(19) United States
(12) Patent Application Publication
(10) Pub. No.: US 2014/0111329 A1
(43) Pub. Date: Apr. 24, 2014

(54) Use Privacy Indicator Method and Apparatus

(71) Applicant: Gary M. Tearston, Los Angeles, CA (US)

(72) Inventor: Gary M. Tearston, Los Angeles, CA (US)

(21) Appl. No.: 13/656,614

(22) Filed: Oct. 19, 2012

(51) Int. Cl. G08B 21/22

(52) U.S. Cl. CPC G08B 21/22
USPC 340/521; 340/669

(57) ABSTRACT

A privacy indicator is disclosed that uses a controller on an inside of a door with an indicator on the outside of the door, thereby optionally indicating a “busy” or “in use” state, or privacy request inside the door. A vertical-orientation-adjustable magnetic or acceleration sensitive switch may be used to cancel the “in use” state. An initial adjustment circuit is used to adjust the vertical position of the switch to allow for vertically misaligned mounting surfaces. The latched “in use” condition serves as a privacy request, reducing embarrassment when used in toilet stalls or bathrooms, or when other potentially embarrassing activities are being performed. Upon opening of the door, a radial acceleration is induced on a pendulum switch, whereupon the latched condition is cancelled, and the indicator no longer indicates the latched privacy request condition.

### CROSS-REFERENCE TO RELATED APPLICATIONS

This application is a continuation-in-part of co-pending U.S. patent application Ser. No. 13/008,871 filed Jan. 18, 2011 hereby incorporated by reference, which is a continuation-in-part of U.S. patent application Ser. No. 12/616,601 filed Nov. 11, 2009.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to status indicators, more particularly to status indicators that indicate usage behind a door, and still more particularly to privacy, or “in use” indicators that indicate usage behind a bathroom or toilet stall door, bedroom, or library, where the indicator may be removable and portable or permanently installed.

2. Description of Related Art Including Information Disclosed Under 37 CFR 1.97 and 1.98

In many cases a locked door may indicate that a room is occupied and that entry is not permitted. While a person attempting to enter a room might suffer potential embarrassment or inconvenience when a locked door is encountered, the occupant of the room might find that preferable over providing a public indicator of occupancy. In other situations, a visible or audible indicator of occupancy might be preferable as a deterrent to attempts to enter the locked room.

Door locks are well known in the art and have been designed in various forms, including those that are mechanically, magnetically, or electrically operated. For example, mechanical locking mechanisms controlled by electric switches have been developed where outside and inside wall switches control a mechanical lock and, in some cases, also control a privacy indicator.

Privacy indicators currently available are generally associated with a locking mechanism of the door so that when an occupant leaves the room and unlocks the door, the occupancy indicator is cancelled. Those indicators that electrically signal the state of occupancy, and are not associated with door locks generally require a make-and-break contact across the door jamb, or a motion detector somewhere in the room or on or near the door.

Privacy indicators are also well known in the art and have been designed in various forms, including double-sided signs that can be hung on the exterior of a door where the signs are to be turned around to indicate occupancy before an occupant enters the room, and then turned back around to a indicate vacancy when the occupant exits the room.

### BRIEF SUMMARY OF THE INVENTION

An aspect of the invention is a method of indicating a request for privacy, comprising: providing a door; mounting a controller on one side of the door, wherein the controller comprises an adjustable rolling ball motion detector; mounting an indicator on the other side of the door; means for activating an “in use” state in the controller; whereby the controller causes an “in use” indication on the indicator.

The method above may also comprise cancelling the “in use” state in the controller. The means for activating may comprise a flip flop, which may comprise a J K̅ flip flop.

The method of mounting of the controller may also cause an “in use” indication on the controller when the “in use” condition is present on the indicator. Additionally, the cancellation off the “in use” state in the controller may be caused by opening the door. The cancellation may be caused by conduction of an adjustable rolling ball motion detector.

In still another aspect of the invention, a privacy indicator apparatus is provided that comprises a controller an indicator electrically connected to the controller; and means for indicating a latched state of the controller; wherein the controller comprises a novel adjustable rolling ball motion detector.

In yet another aspect of the invention a privacy indication apparatus is provided that comprises an indicator electrically connected to a controller and means for changing a state in the controller, wherein the means for changing the state in the controller comprises a four pole double throw switch and means for electrically interconnecting the latching relay and the four pole double throw switch. This latter means comprises a flip flop, a momentary switch capable of initially setting the flip flop and capable of resetting the flip flop, wherein the adjustable rolling ball motion detector includes a uniquely configured base having a concave surface upon which an electrically conductive ball rolls between a center position, a first displaced position in engagement with a first conductive terminal connected to the base and a second displaced position in engagement with a second conductive terminal connected to the base.

In the preferred form of the invention the controller is removably attached to one side of the door and the indicator is attached to the opposite side of the door. Uniquely, the attachment of the controller and the indicator to a door requires no penetration of the door.

Further aspects of the invention will be brought out in the following portions of the specification, wherein the detailed description is for the purpose of fully disclosing preferred embodiments of the invention without placing limitations thereon.

### BRIEF DESCRIPTION OF SEVERAL VIEWS OF THE DRAWINGS

The invention will be more fully understood by reference to the following drawings which are for illustrative purposes only:

FIG. 1A is perspective view of an “in use” privacy indicator mounted upon an opened door.

FIG. 1B is the perspective view of the “in use” privacy indicator with the door further opened so that the indicator may be viewed.

FIG. 2A is an exploded perspective view of a removable “in use” privacy indicator.

FIG. 2B is an assembled perspective view of the removable “in use” privacy indicator of FIG. 2A.

FIG. 3A is an exploded perspective view of a permanently mounted “in use” privacy indicator.

FIG. 3B is an assembled perspective view of the permanently mounted “in use” privacy indicator of FIG. 3A

FIG. 3C is an exploded perspective view of the removable “in use” privacy indicator of FIG. 3A, here using double side acrylic foam adhesive tape for a removable mount.

FIG. 3D is an assembled perspective view of the removable “in use privacy indicator of FIG. 3C.

FIG. 4A is an exploded perspective view of an alternate embodiment of a permanently mounted “in use” privacy indicator.

FIG. 4B is an assembled perspective view of the permanently mounted “in use” privacy indicator of FIG. 4A.

FIG. 5A is an exploded perspective view of a removable “in use” privacy indicator mounted to a door that uses a pendulum switch type of control and indicator using a metal bracket with a clamp to surround the free edge of the door combined with the elastic straps around the hinged side of the door to hold the controller and indicator tight against the door, where the metal bracket may be replaced with a fabric, electrically conductive strip, or conductive tape.

FIG. 5B is an assembled perspective view of the “in use” privacy indicator of FIG. 5A, where the removable metal bracket and strap holds the controller and indicator tight against the door and without any necessity for making a penetration through the door.

FIG. 6A is a perspective view of a magnetically latched privacy indicator installed on a door and door jamb.

FIG. 6B is a perspective view of the magnetically latched privacy indicator of FIG. 6A, with the door ajar, and the magnetic latch connection broken.

FIG. 6C is a top view of the magnetically latched privacy indicator of FIG. 6A with the top cover removed, showing internal details of the magnetic latching apparatus.

FIG. 6D is a top view of an alternate form of the privacy indicator.

FIG. 7A is a schematic circuit of one embodiment of a pendulum style “in use” privacy indicator as typically implemented.

FIGS. 7B and 7C comprise the schematic circuit of one embodiment of a pendulum style “in use” privacy indicator as typically implemented of FIG. 7A with a vertical offset adjustment circuit attached.

FIG. 8A is an exploded view of one embodiment of an acceleration sensitive switch.

FIG. 8B is a partially assembled side view of the embodiment of FIG. 8A.

FIG. 8C is a fully assembled side view of the embodiment of FIG. 8A.

FIG. 8D is a fully assembled side view of the embodiment of FIG. 8A, adjusted for mounting on a tilted surface.

FIG. 8E is the fully assembled side view of the embodiment of FIG. 8C under an acceleration-initiated contact.

FIG. 8F is a fully assembled top view of the embodiment of FIG. 8A.

FIG. 9A is an exploded view of an alternate embodiment of an acceleration sensitive switch.

FIG. 9B is a partially assembled side view of the alternate embodiment of FIG. 9A.

FIG. 9C is a fully assembled side view of the alternate embodiment of FIG. 9A.

FIG. 9D is a fully assembled side view of the alternate embodiment of FIG. 9A, adjusted for mounting on a tilted surface.

FIG. 9E is the fully assembled side view of the alternate embodiment of FIG. 9C under an acceleration-initiated contact.

FIG. 9F is a fully assembled top view of the alternate embodiment of FIG. 9A.

FIG. 10 is an exploded view of yet another embodiment of an acceleration sensitive switch.

FIG. 11 is a top view of one embodiment of the invention incorporating the acceleration sensitive switch depicted in FIGS. 8A through 8F.

FIG. 12A is a side view of an improved pendulum switch with a mechanical advantage of D₂/D₁, where the pendulum is normally open hanging at rest.

FIG. 12B is a side view of an improved pendulum switch of FIG. 12A with the switch closed due to a lateral acceleration.

FIG. 13 is an improved privacy indicator and alignment device using a solid state flip flop to replace earlier switches of FIGS. 7A and 7B.

FIG. 14 is a generally perspective view of an alternate form of the privacy indicator of the invention mounted upon an opened door.

FIG. 15 is a generally the perspective view of the alternate form of privacy indicator invention with the door further opened

FIG. 16 is a greatly enlarged, generally perspective view of the alternate form of the privacy indicator with the door partly broken away to better show the position of the indicator component of the device.

FIG. 17 is a greatly enlarged, generally perspective, exploded view of the controller component of the alternate form of the privacy indicator.

FIG. 18 is an enlarged, generally perspective view of the motion detector component of the controller of the alternate form of the privacy indicator.

FIG. 18A is a generally perspective, exploded view of the motion detector component of the controller of the alternate form of the privacy indicator.

FIG. 19 is a cross-sectional view taken along lines 19-19 of FIG. 18.

FIG. 20 is a cross-sectional view similar to FIG. 19, but illustrating the operation of the adjustment mechanism of the invention for adjusting the level of the base upon which the rolling ball of the motion detector component rolls

FIG. 21 is an enlarged, generally perspective view of an alternate form of the motion detector component of the controller of the alternate form of the privacy indicator.

FIG. 22 is a cross-sectional view taken along lines 22-22 of FIG. 21.

FIG. 23 is an enlarged view of the alternate form of motion detector component of the controller shown in FIGS. 21 and 22 illustrating the operation of the adjustment mechanism of this latest form of the invention for adjusting the base of the motion detector component.

FIG. 24 is a schematic circuit diagram similar to FIG. 7A of one embodiment of the circuit used in controller component of the alternate form of privacy indicator shown in FIG. 17.

FIG. 25 is a schematic circuit diagram similar to FIG. 7B of one embodiment of the circuit used in the controller component of the alternate form of privacy indicator shown in FIG. 17, with a base adjustment circuit attached.

FIG. 26 is an alternate type of circuit shown in schematic form that is similar to FIG. 13 and includes a solid state latching mechanism with an adjustment circuit.

### DETAILED DESCRIPTION OF THE INVENTION

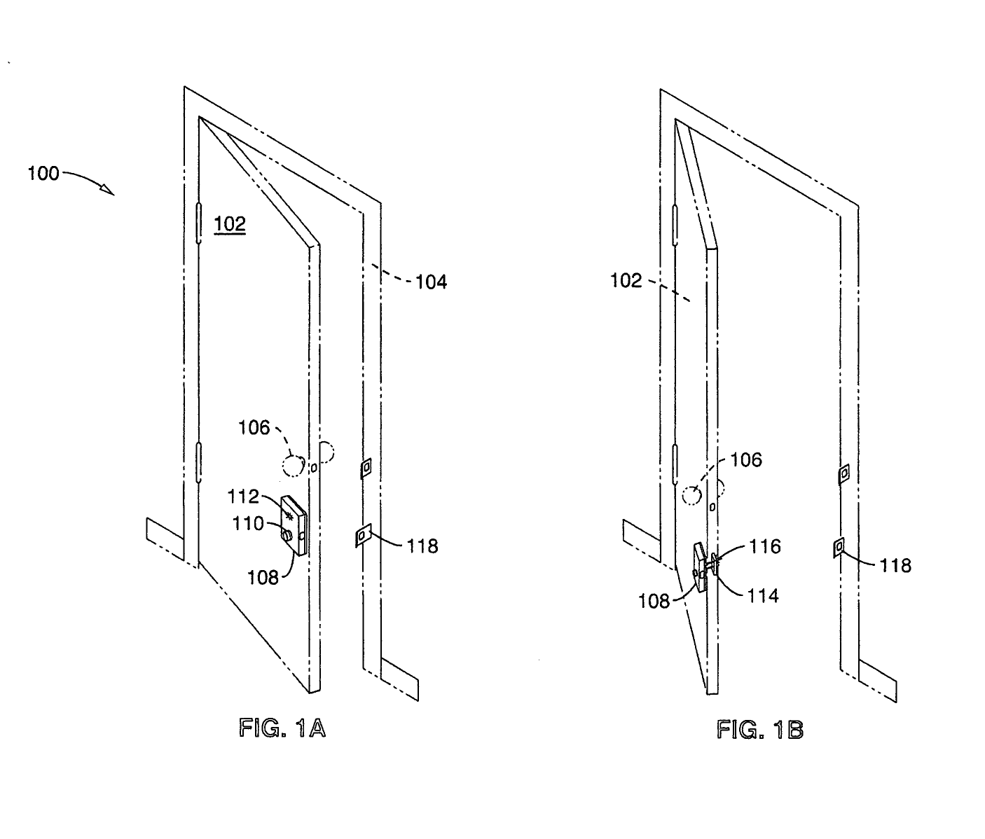

Referring more specifically to the drawings, for illustrative purposes the present invention is embodied in the apparatus generally shown in FIG. 1A through FIG. 13. It will be appreciated that the apparatus may vary as to configuration and as to details of the parts, and that the method may vary as to the specific steps and sequence, without departing from the basic concepts as disclosed herein.

This invention combines the voluntary nature of the occupancy indicator, which is separate from the door locking mechanism. In some embodiments, the occupancy indicator does not require penetration through or disruption of the door. The occupancy indicator may be manufactured at low cost and may be easily applied to an existing door by a home or business owner.

One consideration of this invention is a low-cost solution to a privacy indicator that is completely self-integrated and does not rely on crossing a door jamb, therefore making the unit portable if so desired. It does not require external sensors. Once the occupant sets the controller unit into an “in use” state by means of a switch, the controller remains latched in the “in use” state. Once the occupant opens the door, a single axis pendulum switch acting as a sensitive acceleration switch, causes the controller to latch into a “cancelled” state. The slow opening of a door generates very low acceleration, very much less than 1 g (perhaps 1 ft/sec/sec, rather than 32 ft/sec/sec). Available acceleration switches are both expensive and insensitive at this low acceleration, and low power (3 V and less than 1 mA).

Another consideration of this pendulum acceleration switch is that the pendulum must reach a stable, plumb open switch position almost immediately after initiating its swing oscillation. Having the pendulum swing around a single pivot axis allows this recovery very quickly, even though the motion of most doors is partially rotational. If the pendulum were suspended from a single point allowing full two degree of freedom rotational motion, the rotary oscillation of the pendulum would be difficult to stop almost instantly as required by the circuit. Vertical door surfaces are not always completely plumb to gravity. Therefore there is a vertical adjustment mechanism as part of the pendulum switch accompanied by a simple LED circuit which can help the adjustment process by turning off the LED when the pendulum has reached an open, non-contacting position. This simple LED vertical adjustment circuit is controlled by a DPDT switch which separates the pendulum switch from the main controller circuit and directs it to the LED adjustment circuit. When the vertical adjustment is completed, the DPDT switch is thrown in the direction of connecting the pendulum switch to the controller circuit and disconnecting the pendulum switch from the adjustment LED circuit. This invention embodies two choices for a latching circuit. One uses electromechanical logic using a 4PDT switch and a single coil latching relay. The other embodiment uses a solid-state electronic latch using a bistable J K̅ flip flop. The door attachment mechanism of the inside controller and outside indicator can be both temporary and permanent.

The activation of the occupancy indicator is initiated voluntarily by the occupant of the room, after the door is closed, by pushing a button or sliding a bar.

Appropriate signage on the internal door surface explains the use of the occupancy indicator, and also on the external door surface explaining occupancy related to the LED indicator. The signage would be in the appropriate language for the location of this device.

Refer now to FIG. 1A, which is a perspective view of an “in use” privacy indicator mounted to a door 100. Here, door 102 is connected with jamb 104, and opened by a knob 106. An “in use” privacy indicator controller 108 is attached to the door 102. An on/off switch 110 is used to select an “in use” state within the controller 108. A controller 108 indicator light 112 blinks to indicate that the “in use” state has been activated in the controller 108.

Refer now to FIG. 1B, which is the door 102 of FIG. 1A further opened. Now it is possible to observe an indicator 114 on the opposite side of the door 102. In this view, the light 116 on the indicator 114 is shown blinking so as to indicate the “in use” privacy state of the controller 108. Typically, light 116 cannot be observed from the controller 108 side of the door 102, as the door 102 would ordinarily be closed when a request for “in use” privacy was made. Referring to FIGS. 1A and 1B, it is seen that the door 102 is a typical swinging door. This has been drawn as an example, as the controller 108 and indicator 114 may be on sliding doors, folding doors, and pocket doors (perhaps with some decrease in the ability to close). Depending on the specific embodiment of controller 108 and indicator 114, there only needs to be two criteria met by the door 102 to cancel the “in use” privacy state of the controller 108.

In the case of a magnetically switched controller 108, there is a component 118 on the jamb 104 that causes the magnetic retention of a switch (not shown at this point) to be lost when the door is opened.

In the case of an acceleration sensitive switch, there must be a sufficient acceleration imparted upon the door 102, and hence the controller 108, to cause the normally open switch to close.

Both the magnetic switch and the acceleration sensitive switch will be described in detail below.

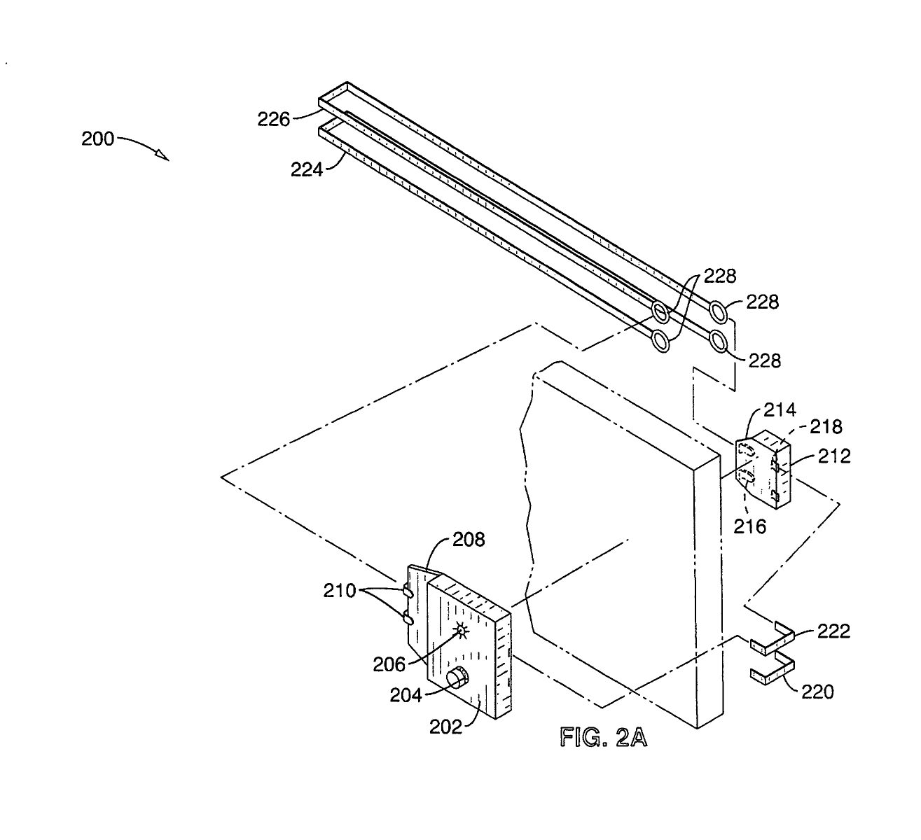

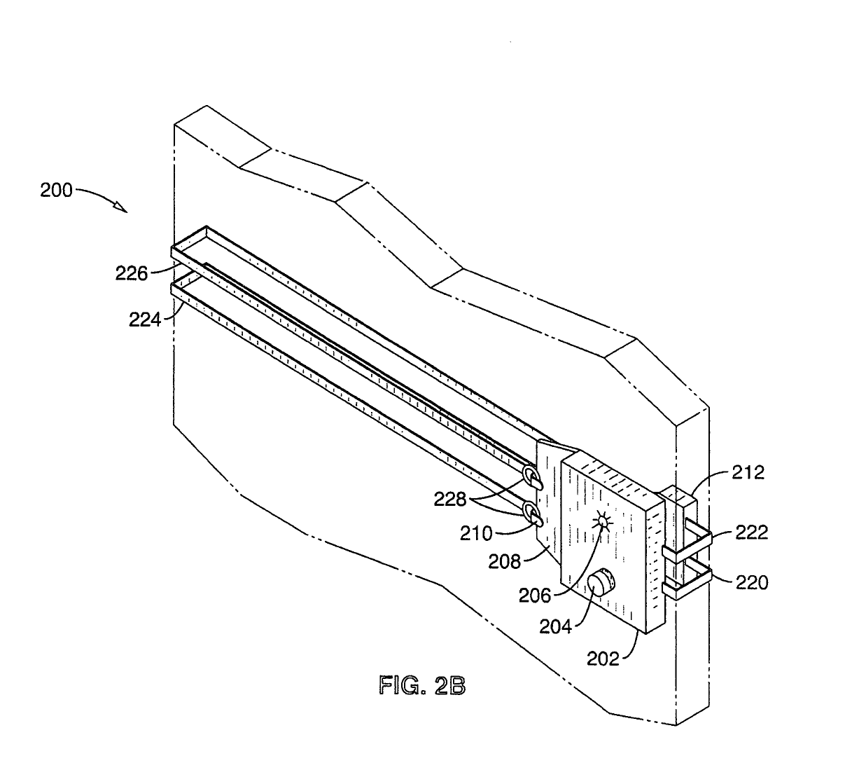

Refer now to FIG. 2A, which is an exploded perspective view of a removable “in use” privacy indicator 200. Here, a controller 202 has an on/off switch 204 readily accessible. An indicator 206, which may be blinking, serves to indicate the “in use” state when so set by the switch 204. Again, the indicator may be a light emitting diode or other visually apparent light source.

A tab 208 protrudes from a back plan of the controller 202 concludes with one or more controller hooks 210, which are hooked features over which a ring or grommet may be removably fastened.

An indicator 212 has a similar tabbed feature 214, which concludes in one or more indicator hooks 216 upon which a ring or grommet may be removably fastened. On the indicator 212 is an indicator light 218, which again may be a light emitting diode or other light producing device. The indicator light 218 indicates the “in use” state present in the controller 202.

A lower conductive strap 220 and an upper conductive strap 222 connect the controller 202 to the indicator 212, thereby forming a circuit loop, and allowing the indicator light 218 to be powered by the controller 202 so as to indicate the “in use” state when present in the controller 202.

The lower conductive strap 220 and the upper conductive strap 222 may be thin strips of metal (say 0.12 inch to 0.2 inch thick), and may be insulated or bare, depending on the type of door the removable “in use” privacy indicator 200 is to be used upon. For instance, when the intended door is conductive metal, as is in many public restrooms, the upper 222 and lower 220 conductive straps would need to be insulated to some degree. For wood doors, however, the straps may be bare conductive metal. These straps may be flexible conductive fabric or thin, flexible metal straps. These straps may be solid or woven metal, or may even be a thin metal film disposed on a woven fiberglass substrate, or attached to a tape, and may be further insulated or bare.

The ends of the lower conductive strap 220 and the upper conductive strap 222 are physically attached to their respective conductors on the controller 202 and indicator 212, either by soldering or by physically screwed attachment. Thus, the straps server the dual purposes of physically and electrically connecting the controller 202 and the indicator 212.

The lower conductive strap 220 and the upper conductive strap 222 wrap around the edge of the door and are sufficiently thin so as to clear the door stop of the door jamb regardless of whether the door stop is on the controller 202 or indicator 212 side.

A lower elastic strap 224 and an upper elastic strap 226 terminate in rings or grommets 228. These rings or grommets 228 are removably attached to controller hooks 210 and indicator hooks 216.

The lower elastic strap 224 and the upper elastic strap 226 might be functionally combined into a single wider strap placed more centrally on the controller 202 and indicator 212. Also the two elastic straps (224 and 226) or single strap might be fabricated from a non-elastic strap fabric whose tension is controlled by a strap adjuster buckle (or spring-type tensioner) attached to the controller 202 or indicator 212, or to an adjustable hook and loop material (frequently referred to as “Velcro™”) positioned at either end of the strap. However, the adjuster buckle and “Velcro™” alternatives are not shown in FIG. 1B.

Refer now to FIG. 2B, which is an assembled perspective view of the removable “in use” privacy indicator 200 as it would be assembled about a door (not shown). Here, it is seen that the lower elastic strap 224 and an upper elastic strap 226 rings or grommets 228 are removably stretched and attached to controller hooks 210 and indicator hooks 216.

The stretching of the lower elastic strap 224 and the upper elastic strap 226 creates a tension that pulls through the controller 202 and the indicator 212, which in turn pulls on the lower conductive strap 220 and the upper conductive strap 222. When installed onto a door, the lower conductive strap 220 and the upper conductive strap 222 pull on one edge of the door, and the lower elastic strap 224 and the upper elastic strap 226 pull on the other edge of the door. When using two such elastic straps 224 and 226, it has been found that the mounting of the controller 202 and the indicator 212 is quite secure. However, a single wider strap more centrally located also provides good stability for the mounting of the controller 202 and indicator 212.

It is not necessary to have a vertical hanging component strap over the top of the door.

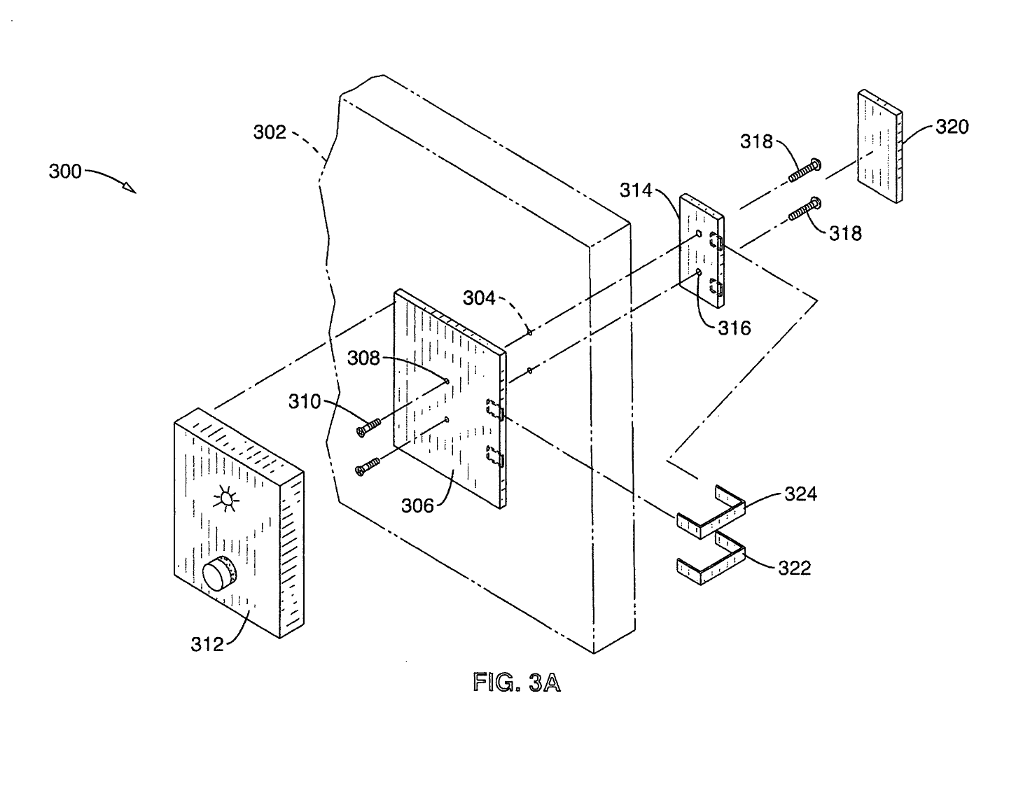

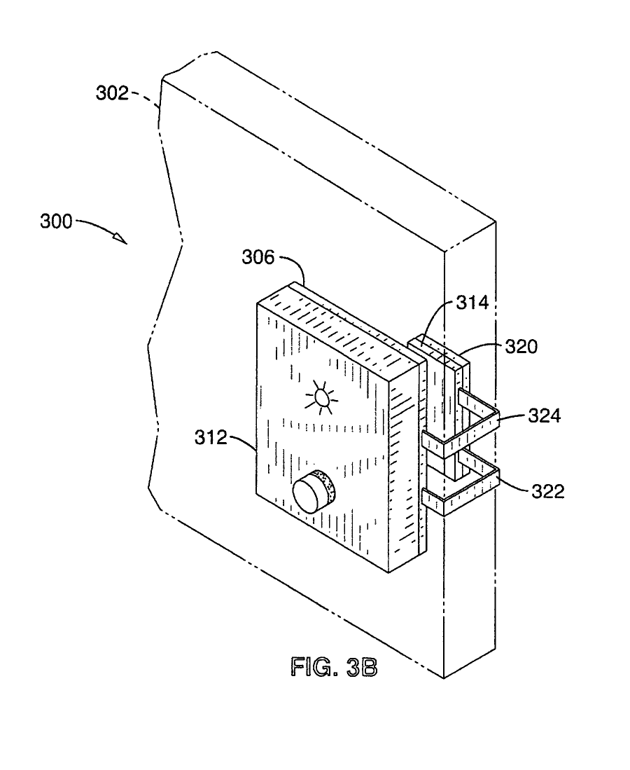

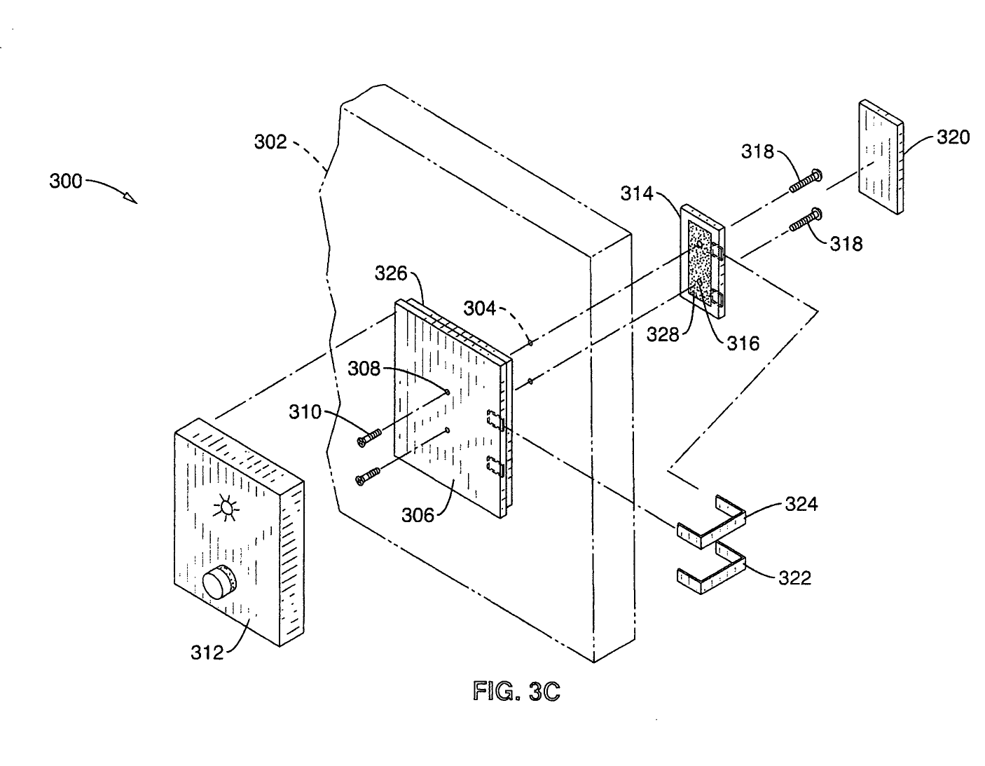

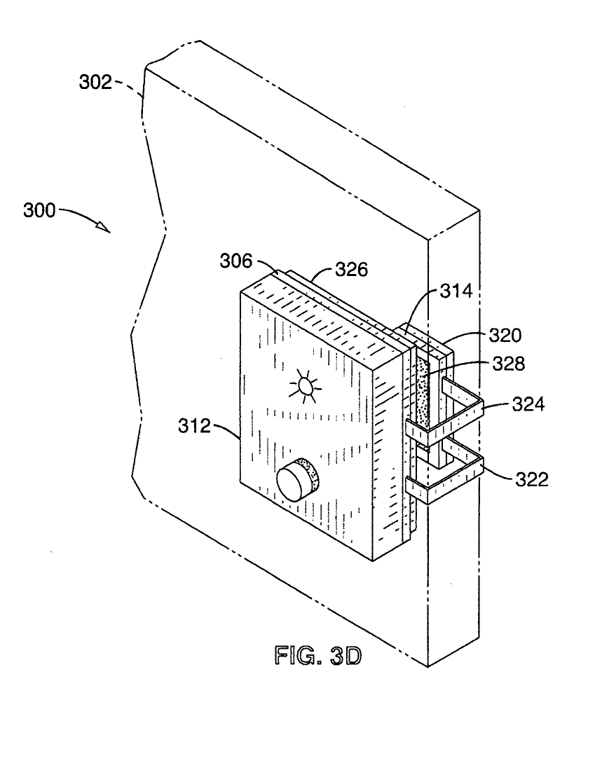

Refer now to FIG. 3A, which is an exploded perspective view of a permanent installation of the “in use” privacy indicator 300. Here, a door 302 is supplied, most likely, but not exclusively, previously installed. Into the door are drilled one or more holes 304 that allowing mounting of a controller base 306 through one or more controller base holes 308. The controller base 306 is secured by one or more screws 310 that secure into corresponding door 302 holes 304. These screws 310 may be wood screws in the case of a wood door 302, or may be self tapping sheet metal screws in the case of a metal door 302. The screws 310 may also be self tapping on a wood door which would obviate the need for hole 304 to be drilled.

After the controller base 306 is secured to the door 302, a controller cover 312 may be secured to the controller base 306.

It should be noted that FIG. 3A shows, for clarity, only the major attachment mechanisms of the controller base 306, without showing other details, such as the power supply, indicators, wiring, circuit board, and acceleration sensitive switch. These details will be described below.

On the other side of the door 302 from the controller base 306, one or more additional holes are drilled into the door, similarly to the earlier holes 304. Into these other holes, indicator base 314 is secured though one or more corresponding indicator holes 316 by indicator screws 318. After the indicator base 314 is secured to the door 302, the indicator cover 320 may be installed over the indicator base 314.

Lower conductive strap 322 and upper conductive strap 324 are shown separated in the exploded assembly view of FIG. 3A, however, it is more likely that the straps are attached to the controller base 306 and the indicator base 314 prior to any installation to the door 302.

Refer now to FIG. 3B, which is a perspective view of the assembled “in use” privacy indicator of FIG. 3A.

Refer now to FIG. 3C, which is an exploded perspective view of the “in use” privacy indicator of FIG. 3A, here using double side acrylic foam adhesive tape 326 and 328 respectively attached to the controller base 306 and the indicator base 314 for a removable mount.

Refer now to FIG. 3D, which is an assembled perspective view of the removable “in use” privacy indicator of FIG. 3C. In this instance, the double side acrylic foam adhesive tape 326 and 328 respectively attached to the controller base 306 and the indicator base 314 serves as a removable mount for the in use” privacy indicator 300.

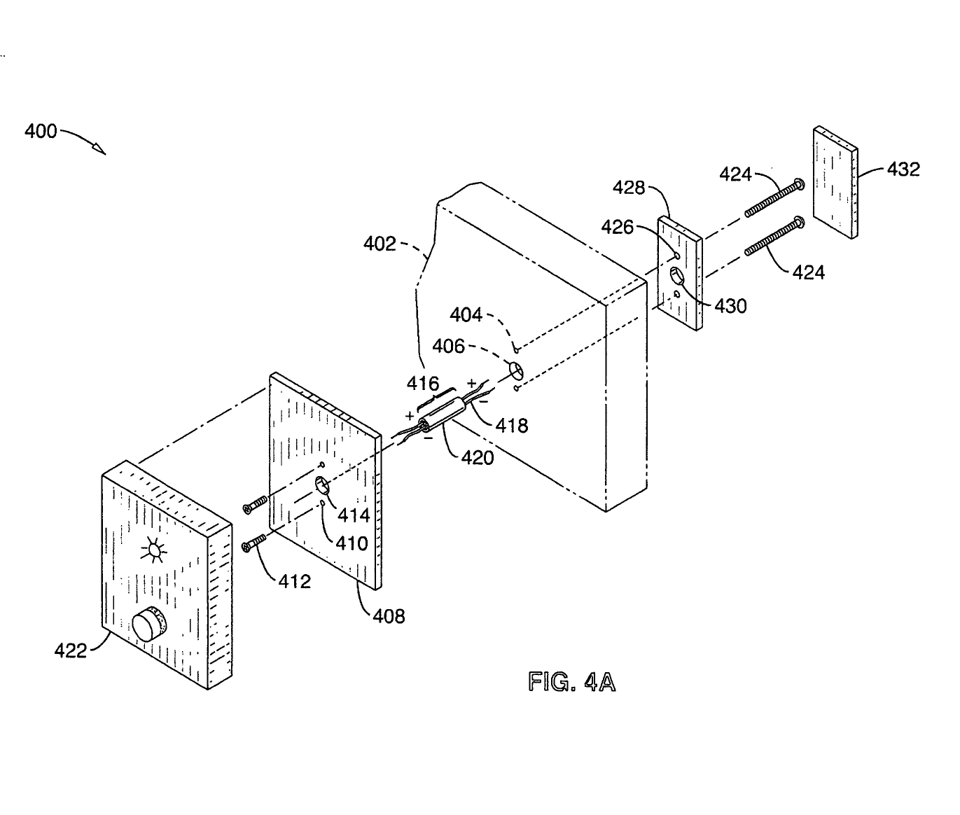

Refer now to FIG. 4A, which is another embodiment of the permanent “in use” privacy indicator previously described in FIGS. 3A and 3B. Here, the door 402 has one or more mounting holes drilled 404. Additionally, another through hole 406 is drilled to allow for electrical connections to be made.

A controller base 408 mounts through one or more corresponding holes 410 to the door 402 with corresponding screws 412. Another hole 414 in the controller base 408 corresponds in size and approximate location to the door 402 through another through hole 406. Through the hole 414 and the door 402 through hole 406 passes a flexible cable assembly 416, which comprises at least two conductors 418 and a protective shroud 420 to protect the conductors 418 from potentially sharp door 402 through hole 406 abrasions. This shroud 420 may be as simple as heat shrink tubing, or may be as rugged as flexible plastic tubing. In the latter case, the plastic tubing would need to be provided at a length greater than the width of the door 402, and then cut down to a length substantially equal to the width of the door 402.

After mounting of the controller base 408 and attachment of the cable assembly 416, the controller cover 422 is attached to the controller base 408.

Similarly, on the other side of the door 402, one or more screws 424 pass through corresponding holes 426 in an indicator base 428 to corresponding drilled holes (not shown) in the door 402. An indicator base 428 larger hole 430 aligns in size and position with the door 402 through hole 406. At this point, the conductors 418 of the cable assembly 416 are connected to circuitry on the indicator base 426, and the indicator cover 4320 is attached to the indicator base 428.

This embodiment allows for a “strapless” implementation of the embodiment of FIGS. 3A and 3B, without the conductive straps wrapping around the edge of the door. The flexibility of the wire and plastic conduit through the door to electrically connect the controller and indicator LED lights requires a less precisely aligned hole through the door than if the conduit were rigid, making the hole location of considerably larger positional tolerance for drilling through the door by the user.

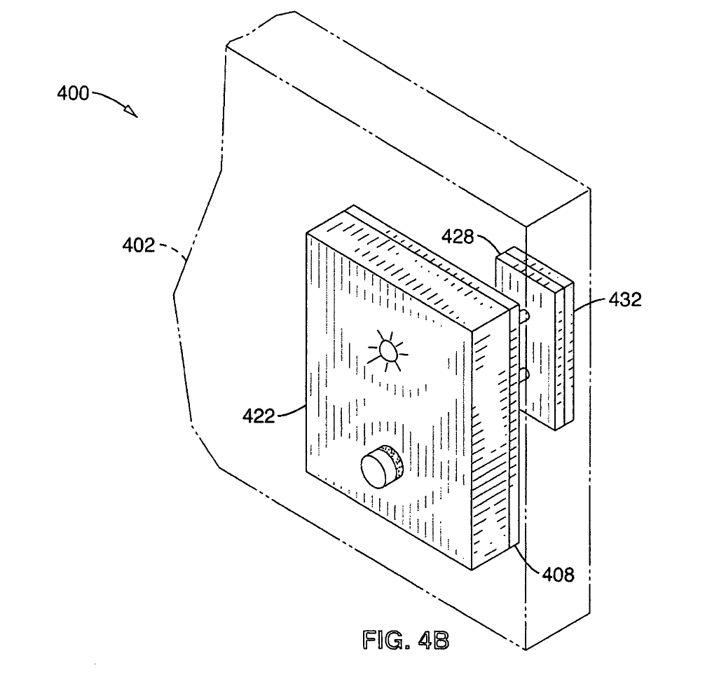

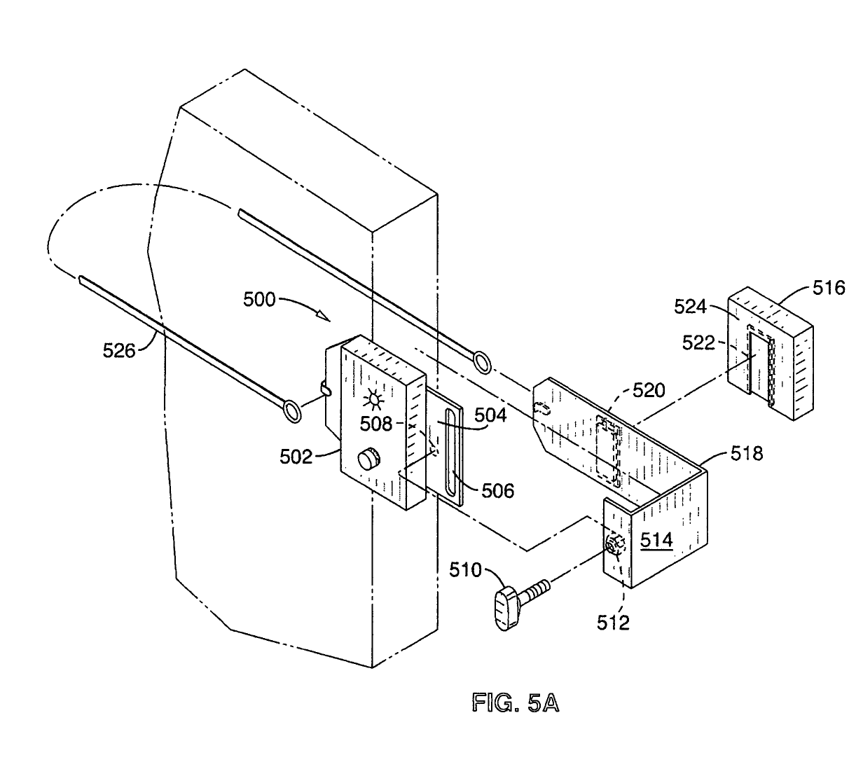

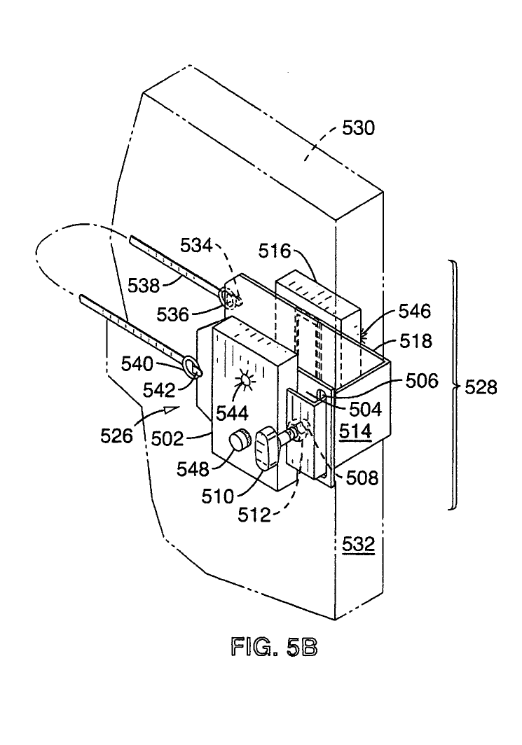

Refer now to FIG. 5A, which is a partially exploded perspective view of yet another embodiment of mounting the “in use’ privacy indicator 500. The “in use” privacy indicator apparatus which flashes indicator (typically, but not necessarily light emitting diodes) to indicate occupancy behind the door, and a desire for privacy, as in, but not limited to a bathroom or toilet facility. This device is easily applied to an existing swinging or sliding door edge in many ways, such as shown here by “clipping” onto a door.

Here, a controller unit 502 mounts to an extended base 504 with a slot 506 and a bearing location 508. A threaded knob 510 threads through a fastener 512 in a “J” shaped mount 514 to press against the extended base 504 at bearing location 508 (this means a load, or force bearing location). The indicator 516 mounts to a back side 518 of the “J” shaped clip 514 onto a conductive attachment tee 520 that slides into a corresponding conductive mating detail 522 in the indicator 516 back side 524. The ““J” shaped clip 514 is not a fully formed “J”, but rather may have one side longer or shorter than the other. Here, the back side 518 is much longer than the side with the fastener 512.

A second conductive strap, not shown in this FIG. 5A, could also complete the indicator circuit around free edge of the door. Yet another alternative would be connecting around the hinged side of the door, thereby connecting separate terminals between the controller unit 502 and indicator 516.

Refer now to FIG. 5B, where a perspective view of the removable privacy indicator is shown mounted to a door 526. Here, the controller 502 with the extended base 504 is assembled 528 by sliding the extended base 504 slot 506 over the “J” shaped clip 514 so that the extended base 504 and “J” shaped clip are loosely assembled. Then, the threaded knob 510 is passed through the fastener 512, ultimately bearing up against the extended base 504 at the bearing location 508 previously shown in FIG. 5A. The indicator 516 may at this point be mounted to the back side 518 of the “J” shaped clip 514. At this point, the apparatus is assembled, and ready to be placed on a door 530.

It should be noted that the slot 506 must have sufficient clearance over the fastener 512 to allow assembly. To accomplish this, the fastener 512 may in fact be threaded into the extended base 504, may be a low-profile threaded insert, or the slot 506 may have additional material removed to provide assembly clearance for the fastener 512.

Typically, extended base 504 comprises a thin spring-type material such as 1095 steel or stainless steel tempered to spring hardness. The spring-like flexibility of extended base 504 aids in threading the slot 506 of fastener 512 over the extended base 504.

With the door 530 opened, the “J” shaped clip 514 is placed over the edge face 532 of the door 530 at a convenient height. Then, the threaded knob 510 is turned sufficiently so that the controller 502 and indicator 516 assembly 528 are mounted on the door 530 sufficiently tight that the entire assembly 528 will be capable of repeated opening and closing of the door 530 without slipping. In such mounting to the door 530, the assembly 528 is well-suited to non-permanent or travel use.

In another embodiment, a tabbed feature 534 is integral with the “J” shaped clip 514 that allows a ring or grommet 536 to be removably fastened. The ring or grommet 536 may in turn be attached to an elastic strap 538 that terminates in a second ring or grommet 540, which may also be removably attached to an extended base 504 tabbed feature 542. In this embodiment, the elastic conductive strap 538 allows for improved retention of the mounted entire assembly 528 to the door 530 through repeated use.

Further, the elastic strap 538 may also be conductive. As such, if the tabbed features 534 and 542 are electrically isolated from the “J” shaped clip 514 and the extended base 504, respectively, then the elastic conductive strap 538 may be used as one conductor if an electrical circuit, with the extended base 504 and “J” shaped clip 514 completing the circuit.

In still another embodiment, an additional conductive strap above and separate from the “J” shaped clip 514 could wrap around the free edge of the door and connect to terminals on the indicator 516 and controller 516.

The “J” shaped clip 514 is typically a conductive metal, and is sufficiently thin that the normal operation of opening and closing the door 520 is not affected.

Typically included would be an indicator light on the controller 544 on the controller 502 and a privacy light 546 on indicator 516. A push-button switch 548 located on the controller 502 allows for turning the request for privacy on or off.

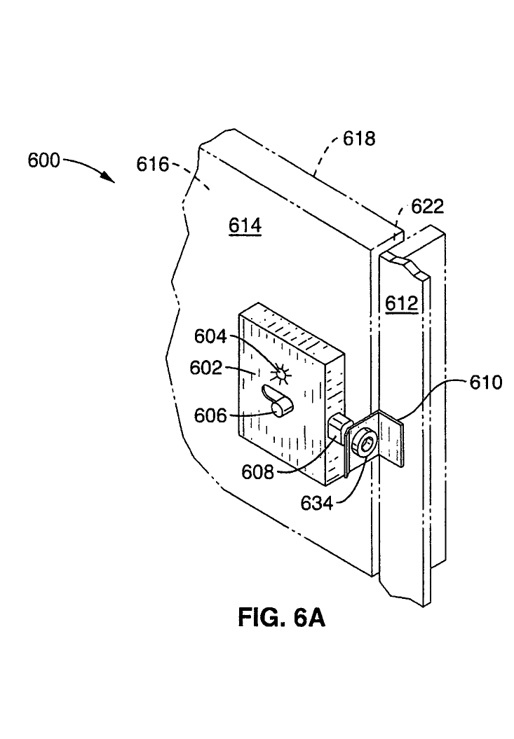

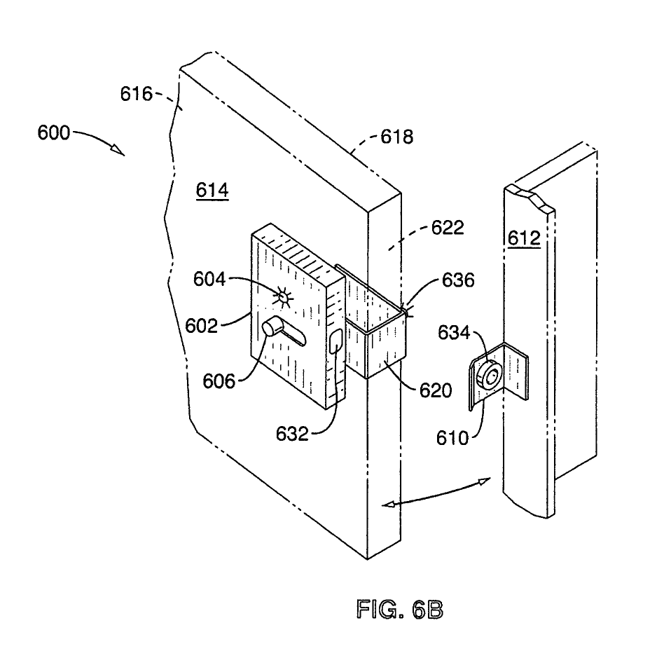

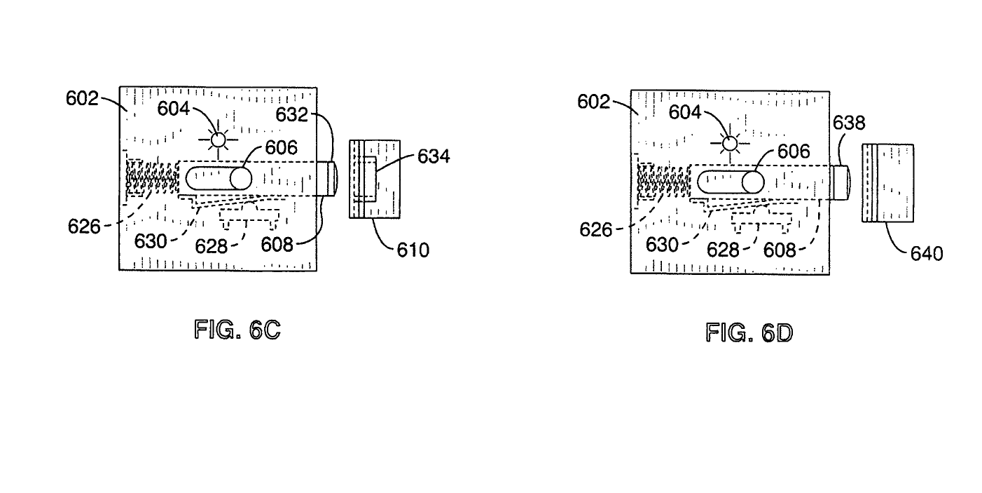

Refer now to FIG. 6A, which is a perspective view of a magnetically latched embodiment a privacy indicator 600. Here, a controller 602 has an indicator light 604 that is lit when privacy is requested, and an on/off switch 606 for when privacy is requested. The on/off switch 606 actuates a magnetically restrained sliding bar 608 that is restrained by a magnetic material 610 mounted on the door jamb 612. The on/off switch 606 may actually be a protruded surface affixed to and riding on a translation of the sliding bar 608.

Both the privacy indicator 600 and the controller 602 are permanently mounted to the door 614 through simple screws or adhesives. One need for permanent mounting in this embodiment of the invention is due to the magnetically restrained sliding bar 608 mechanism, which needs to magnetically interact and line up with the fixed magnetic material 610 mounted on the door jamb 612. It would be difficult to associate a portable strap or clip attachment to the door 614 with the horizontal activation motion of magnetically restrained sliding bar 608.

Ideally, controller 602 is mounted at the extreme radial dimension from the pivot line of the door 614 to allow for a shorter distance of travel of magnetically restrained sliding bar 608 across the door 614 to door jamb 612 opening to engage the fixed ferrous metal or magnetic contact attached to the door jamb. The indicator (e.g. 516 previously shown in FIGS. 5A and 5B) has no positioning requirement for best operation, however, the nearer to the controller 602, the easier it is to connect the two especially if the two are to be connected without conductive straps, and with a hole drilled through the door 614 for flexible electric conductor connection.

Refer now to both FIGS. 6A and 6B. The privacy indicator 600 attaches to both inner 616 and outer 618 door 614 surfaces, and has a component 620 which wraps around the door edge 622 to provide conduction to a low voltage battery circuit to light the light emitting diodes (LEDs) on both inner 616 and outer 618 door surfaces.

Note that here, component 620 is shown as a single component, which internally possesses at least two independent conductors. Component 620 could also be replaced with two separate conductors as previously shown in FIGS. 2A, 2B, 3A, and 3B.

It should also be noted that component 620 fits within the clearance between the door edge 622 and the door jamb 612. Ideally, component 620 is very thin, allowing for minimal interference with the door edge 622 to door jamb 612 clearance, and additionally is sufficiently thin to allow for normal closure of the door 614 into the door jamb 612, regardless of any previously installed door 614 closure mechanism (such as a latch, lock, dead bolt, knob, etc.)

Activation of the privacy indicator 600 device is controlled by the occupant on the inner 616 side of the door 614 by a sliding a bar 608 by means of the on/off switch 606, which sliding closes an electrical lever arm switch.

Refer now to FIG. 6C, which shows an interior view of the controller 602 with the top cover removed. The bar 608 has attached to it protruded surface 606 (that acts as an on/off switch 606) for extending the bar 608. An extension spring 626 (to keep the electric switch in a normally open position) provides tension on the bar 608 at all times. An electric switch 628 is actuated by the sliding action of the bar 606 on taper 630.

Refer now to FIGS. 6A-6C, the bar 608 extends through the controller body 602, terminating in a steel or iron tip 632. With the steel, iron, or otherwise paramagnetic tip 632, the sliding bar 608 engages a small magnet 634 affixed 610 to the door jamb 612 across the narrow gap between the door edge 622 and the door jamb 612. The small magnet 634 may be decorative in nature, allowing for an aesthetic permanent placement.

When the on/off switch 606 is caused to move, sliding the bar 608 to which it is attached translates, causing the taper 630 to also translate. At some point, the translation of the taper 630 is sufficient to actuate switch 628 and physically contact the magnet 634 mounted on the door jamb 612.

When electrical switch 628 is closed, a blinking circuit is activated and the light emitting diode 636 flashing mechanism is activated. The small permanent magnet 634 affixed to the door jamb 612 engages the metal tip 632 on the sliding bar 608 mechanism and holds the electric switch 628 in a closed contact position until either the door 614 is opened or the on/off switch 606 mechanism is manually moved in a away from the door 614 edge 622.

When the door 614 opens or the occupant physically opens the on/off switch 606, the magnetic mechanical contact is broken and the extension spring 626 retracts the bar 608 away from the door 614 edge 622 and opens the electric switch 628 turning off the flashing light emitting diode 636. The extension spring 626 operates to pull back the sliding bar 608, which translates a taper 630, that reduces a displacement on the lever arm of the electric switch 628, which then opens the electric switch 628, thus turning off the LED privacy indicator light emitting diode 636.

An energy saving circuitry is used to extend battery life with intermittent use up to 1-2 years (when using alkaline 1.5V AA sized batteries.) It is an addition to any existing privacy door to indicate occupancy. The device is purposefully designed to avoid penetrating through the door as would be necessary in order to replace or add a locking mechanism, or to pass electrically wire between external and internal surfaces of the door. The simplicity of its design allows for low cost of production and ease of installation. However, should the user desire a more permanent or relatively tamperproof electrical connection, a hole may be drilled through the door to pass the electrical connections between the indicator and controller.

In one embodiment, the energy supply for the LED indicator lights 636 comes from batteries, likely two common and inexpensive AA 1.5V alkaline cells (e.g.: Eveready or Duracell) in series to produce a nominal output of 3V with a stored energy of about 2500 mAH. By using blinking LEDs activated by a pulse width modulation battery sparing circuit, perhaps using a CMOS 555 timer (e.g.: Radio Shack TLC555/TLC555CP) circuit, battery life should be extended with intermittent use from six months to over one year. Continuous use of the LED indicators would theoretically give a battery life of approximately 3 months.

The batteries and switch mechanism will be on the internal surface of the door. Electric power to the LED indicator on the external surface of the door may be transmitted using insulated adhesive electrical conductive tape (e.g.: TAPERWIRE 222-WT/222-CL) wrapped around the free edge of the door, which may be replaced easily should it become worn.

The internal and external components of the occupancy indicator and the small permanent magnet on the door jamb may be attached by adhesive, adhesive tape, or small surface screws. The magnet on the door jamb may be a small ring type Neodymium magnet, approximately ½″ in diameter (e.g.: Master Magnetics Inc part number NR004705N). The ring type magnet allows fastening to the door jamb using either a small attaching screw through the center of the ring magnet, or by use of adhesive material

Refer now to FIG. 6D, which is an alternative embodiment of the device of FIG. 6C. Here, the sliding bar 608 terminates in a magnetic component 636, which is in turn magnetically attracted to a paramagnetic material 638 such as iron or steel, which is in turn attached to the door jamb 612 (shown in FIG. 6B).

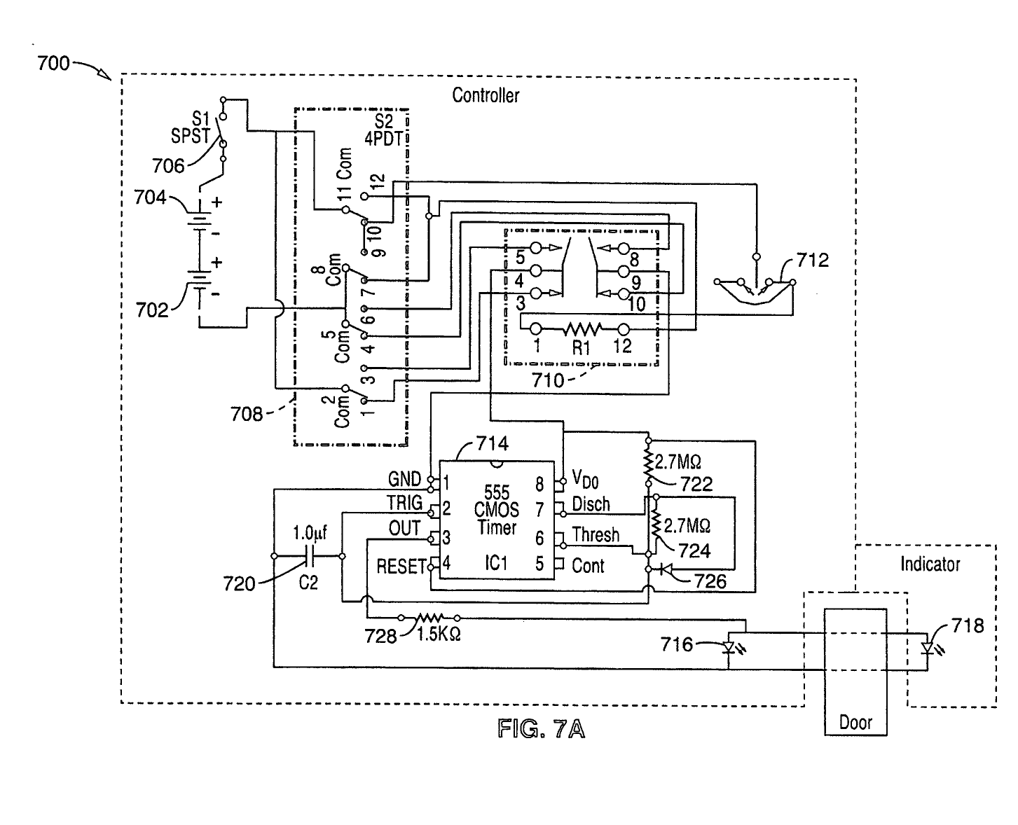

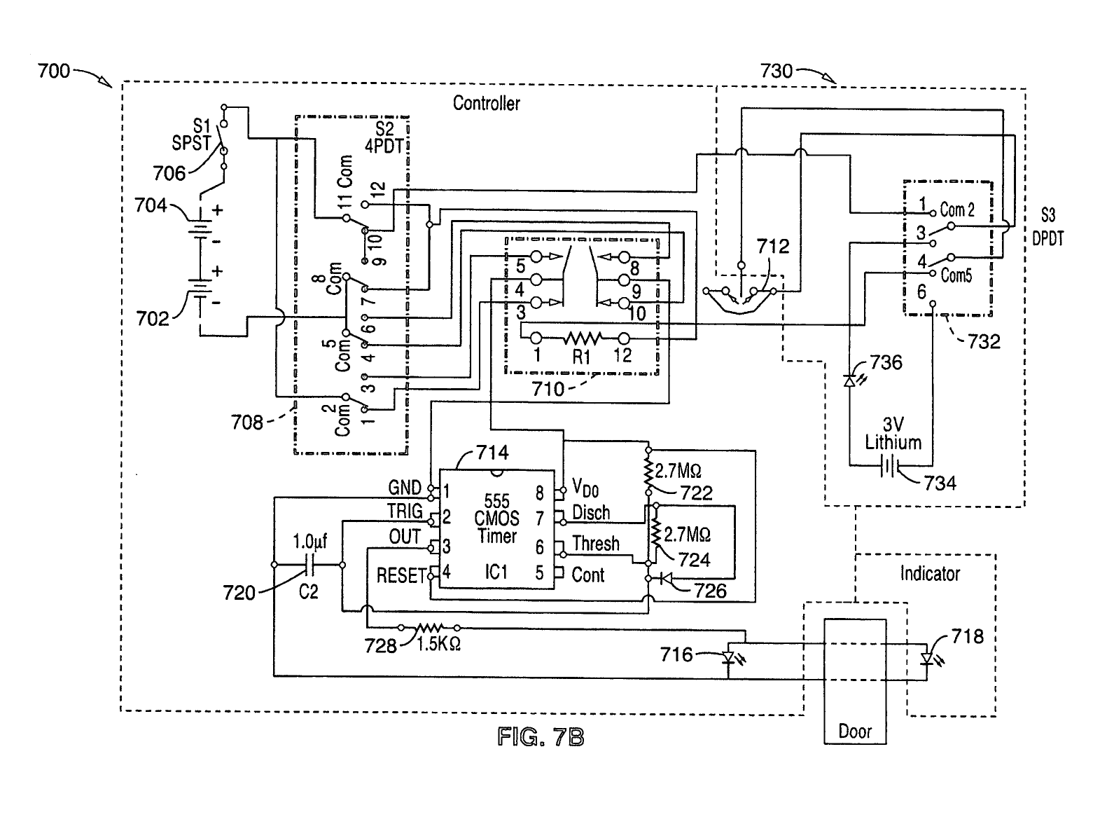

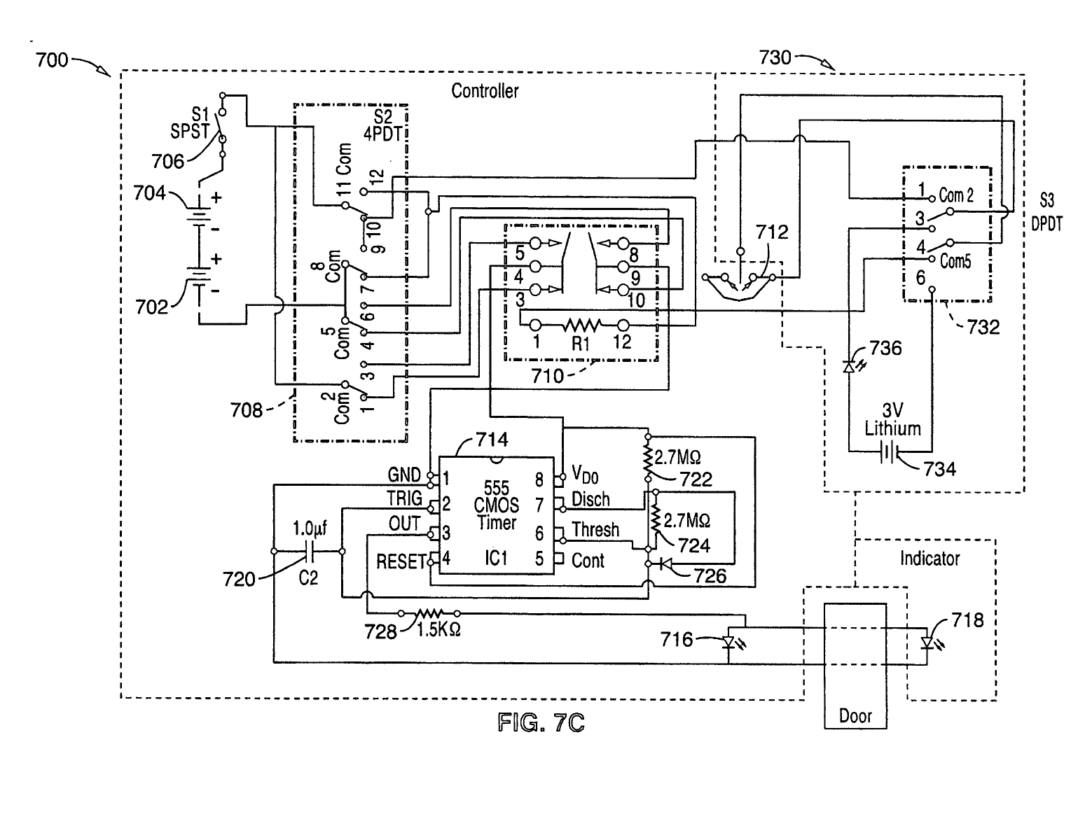

Refer now to FIG. 7A, which is a schematic of a circuit 700 used in the pendulum style privacy indicator. This schematic represents the use of an electromechanical latching mechanism. The schematic for the circuit for a solid-state latching mechanism will be demonstrated later in this discussion. Here, two batteries 702 and 704 are placed in series to provide power to the circuit 700. The batteries 702 and 704 would likely be alkaline cells, although other batteries combining to produce an output voltage from 2.8-3.5 volts would also be acceptable. Additionally, with circuitry redesign for other voltages, still other battery supplies could be used.

The batteries 702 and 704 are switched by S1, a single pole single throw (SPST) switch 706 that operates to disconnect the batteries 702 and 704 from periods of nonuse. Such periods of nonuse would include when the portable privacy indicating unit is being stored in a drawer. S2 is a push button 4 pole double throw (4PDT) switch 708 that in one state resets the privacy indication “off”, and in the other state initiates a privacy indication of “in use”. 4 pole double throw switch 708, when triggering the “in use” state, energizes R1, the single coil latching relay 710 to set the “in use” state. Conversely, release of the 4PDT switch 708 resets the single coil latching relay 710 to an “off” state.

The single coil latching relay was previously a Panasonic TX2-L-3V relay; however, it was replaced by a lower cost Tyco Electronics 5-1462037-0 single coil latching relay. The latter relay also possessed a larger operational voltage spread.

The “in use” state may be cancelled by turning off S1, the SPST switch 706 for main power, or by switching “off” the 4PDT switch 708. Finally, the “in use” state may be cancelled by a momentary connection of the pendulum switch 712, which operates to reset the single coil latching relay 710 to the “off” state.

While the “in use” state is active, IC1, typically a CMOS 555 timer 714 operates to control the “blinking” of output light emitting diodes (LEDs) 716 and 718. Alternatively, the LEDs 716 and 718 may have a built-in integrated flashing mechanism, where the CMOS 555 timer 714 is used to modulate the blinking and conserve power. Typically one of these LEDs is present in the controller unit (previously described) and another in the indicator unit (also previously described). The rate of “blinking”, and consequent power consumption, is controlled by C2, a 1 μF capacitor 720, resistors 722 and 724 that are 2.7 MΩ, and diode 726. The current supplied to LEDs 716 and 718 is limited by a 1.5 kΩ resistor 728. The specifications of the components mentioned above are used with a self-flashing LED with an internal integrated circuit for blinking. The CMOS 555 timer 714 is used to conserve power by switching off the LEDs 716 and 718. The battery life of two 1.5V Alkaline batteries 702 and 704 in series is calculated to power continuous “in use” blinking for at least 3 months, and has been tested to last at least 5 months. Intermittent “in use” usage at 20% to 50% is calculated to extend battery life to greater than one year.

To further elucidate, the “in use” state and its cancellation are controlled by a 4PDT switch 708, a single coil 2PDT latching relay 710, and a single direct current power source (comprising batteries 702 and 704). One side of the 4PDT switch 708 controls alternating polarity to the single coil 2PDT latching relay 710 coil (indicated as a resistor between pins 1 and 12) through the momentary pendulum switch 712.

The power contacts in the latching relay are supplied alternately from one or the other side (throw) of the 4PDT switch 708. When SPST switch 706 is closed as normally used, the power from the batteries 702 and 704 is transmitted respectively to the positive common contacts 11 and 2, and the negative common contacts 5 and 8 of the 4PDT switch 708. The four output contacts of the 4PDTswitch 708 (contacts 1, 3, 4, and 6) on the side assigned to current passing to the power contacts of a 2PDT latching relay 710, are arranged (contacts 1 and 3 positive) and (contacts 4 and 6 negative). When the 4PDT switch 708 is switched in one direction, contacts 1 and 4 are closed, thereby passing current respectively to contacts 3 and 10 on the 2PDT latching relay 710.

When the 4PDT switch 708 is switched in the alternate sense, contacts 4 and 6 are closed, while contacts 1 and 3 are opened, and current now passes from contacts 4 and 6 respectively to contacts 5 and 8 on the 2PDT latching relay 710.

Whether the power current flowing through the 4PDT 708 to the 2PDT single coil latching relay 710 results in a “in use” state depends on whether the 2PDT single coil latching relay 710 is latched in the direction to allow current to pass from contacts 5 and 8 (respectively out through contacts 4 and 9), or latched in the direction to allow current to pass from contacts 3 and 10 (respectively out through contacts 4 and 9) to the CMOS 555 timer 714 “blinking” LED circuit.

The state of latching in the 2PDT single coil latching relay 710 depends on the polarity of coil R1 contacts 1 and 12 faced at the last pendulum switch 712 momentary closure.

Assume FIG. 7A represents an “in use” state of the circuit so that current is passed from contacts 1 and 4 on the 4PDT switch 708 to respective contacts 3 and 10 on the 2PDT single coil latching relay 710. Therefore the 2PDT single coil latching relay 710 is latched so that positive power contacts 3 and 4 are closed, and negative power contacts 10 and 9 are closed, thereby allowing current to pass to CMOS 555 circuit 714. Notice that the coil R1 contact 12 is connected to the 4PDT switch 708 negative contact 8, and R1 contact 1 is potentially connected to 4PDT switch 708 positive contact 11. If the pendulum switch 712 momentarily closes, then the actual current will flow to the coil R1 and the 2PDT latching relay 710 will latch in the opposite direction so positive contacts 3 and 4 will open and contacts 4 and 5 will close, and negative contacts 10 and 9 will open and contacts 9 and 8 will close.

Since there is no power passing from the 4PDT switch 708 to contacts 5 and 8 on the 2PDT latching relay 710, the circuit goes into a cancelled “in use” state until the 4PDT switch 708 is thrown to the alternate switch position, after which contact 3 (positive) and contact 6 (negative) on the 4PDT switch 710 become closed, and thereby pass current to respective contacts 5 and 8 on the 2PDT latching relay 710, which, in this scenario through the pendulum switch 712, have been previously latched to output contacts 4 and 9 thus supplying power to the CMOS 555 timer 714 circuit and reactivating an “in use” blinking state.

Note from FIG. 7A that when the 4PDTswitch 708 is thrown to the alternate position, positive contact 11 through contact 12 on the 4PDT switch 708 will be connected to contact 12 on the 2PDT single coil latching relay 210, and negative contact 8 through contact 9 on the 4PDT switch 708 will be connected through the open pendulum switch 712 to contact 1 on the 2PDT single coil latching relay 710. This then establishes a possible reverse of polarity to the single coil R1, which will become an actual current once the pendulum switch 712 momentarily closes and creates an alternative latching and a canceled “in use” state.

The general principle to be observed in connecting the 4PDT switch 708 with the 2PDT single coil latching relay 710 is that the power output contacts of the 4PDT switch 708 passing to the power input contacts on the 2PDT single coil latching relay 710 creating an “in use” state, should, simultaneously in the same throw, carry to the single coil R1 the reverse polarity of current which when activated by the pendulum switch will latch to the side of the 2PDT single coil latching relay 710 which will open the circuit creating the cancelled “in use” state.

In the “in use” state where the CMOS 555 timer 714 “blinking” LED circuit is active continues until either the 4PDT switch 708 is thrown in the opposite direction removing power to the active side of the single coil 2PDT latching relay 710, and reversing the potential R1 coil polarity coming out of the 4PDT switch 708 to the same polarity that sustains the current latched state so that if the pendulum switch now closes the current “cancelled” state remains until the 4PDT switch 208 is thrown back to the original “in use” state; after which the potential R1 coil polarity from the 4PDT switch 208 is set back to the potential reverse latching” canceling” state if the pendulum switch 712 is momentarily closed.

The closure of the pendulum switch 712 now carries the opposite polarity, which reverses the current supplied to the single coil 2PDT latching relay 710 driver coil between pins 1 and 10 and thereby throws the latching mechanism with the single coil 2PDT latching relay 710 to the side of the single coil 2PDT latching relay 710, which is now opened and thereby breaks the power supply to the CMOS 555 timer 714 “blinking” LED circuit until the 4PDT switch 708 is reversed again

The state of latching in the 2PDT single coil latching relay 710 depends on the polarity of coil R1 contacts 1 and 12 faced at the last pendulum switch 712 momentary closure.

Refer now to FIG. 7B, which is the circuit 700 of FIG. 7A with a vertical adjustment circuit 730 added. Here, the vertical adjustment circuit 730 connects to the pendulum switch 712 through a double pole double throw switch, DPDT SW3, 732. Note that the pendulum switch 712 is connected to the common pins 2 and 5 of switch 732. Note that when the switch 732 is thrown connecting the common pins 2 and 5 to pins 1 and 4 respectively, the pendulum switch 712 is part of the controller circuit 700.

When the switch 732 is thrown in the direction of pins 3 and 6, the pendulum switch 712 is disconnected from the controller circuit 700, and is part of the vertical adjustment circuit 730. The 730 circuit has its separate power supply 734 (3V lithium battery) and LED indicator 736 remains lit so long as the pendulum contacts are closed. Once the pendulum adjustment, (to be described later) is completed, and the pendulum switch 712 rests in a stable nonconductive open state, the indicator LED 736 is no longer lit. The pendulum switch 732 can now be thrown back connecting the common pins 2 and 5 to pins 1 and 4 thus disconnecting the pendulum switch 712 from the vertical adjustment circuit 730 and reconnecting it to the controller circuit 700.

In many implementations, the vertical adjustment circuit 730 need only to be used initially, with the vertical plane of the pendulum switch 712 remaining permanently mounted in the vertical axis. In this scenario, the vertical adjustment circuit 730 may be used once, and never be needed again for help in adjusting the pendulum switch.

Alternatively, should the vertical axis of the pendulum switch 712 change regularly (e.g. in a recreational vehicle that frequently moves, or in a removable temporary mount which changes locations), the vertical adjustment circuit 730 may be available for continuous vertical alignment usage.

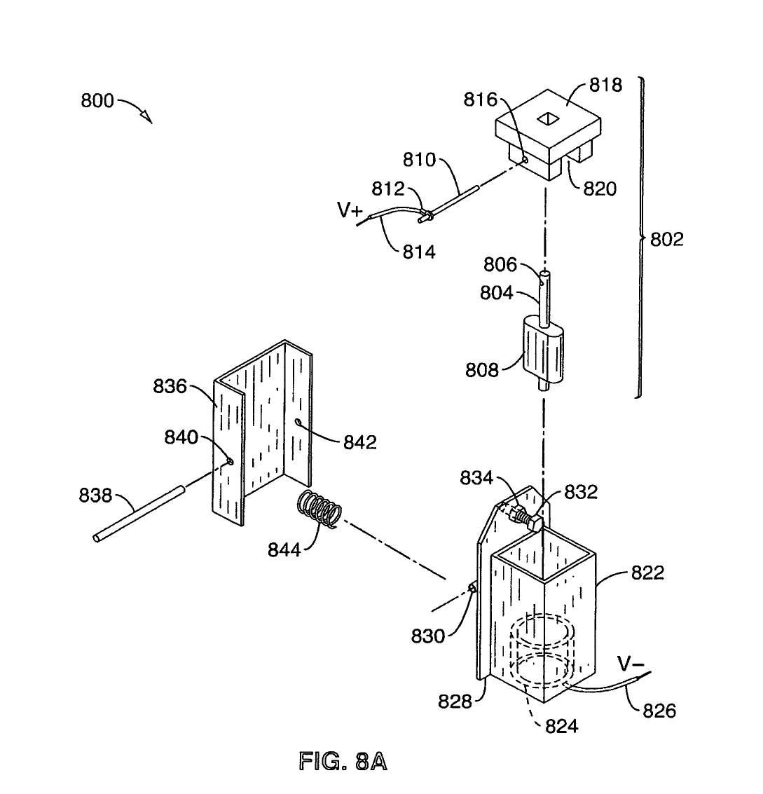

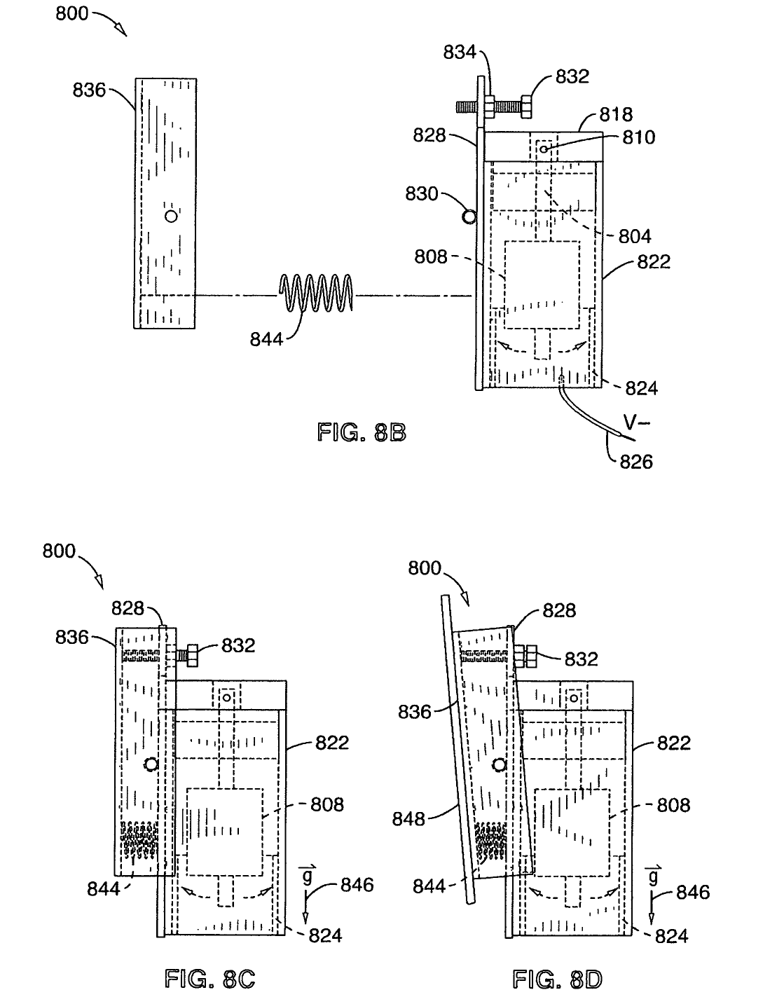

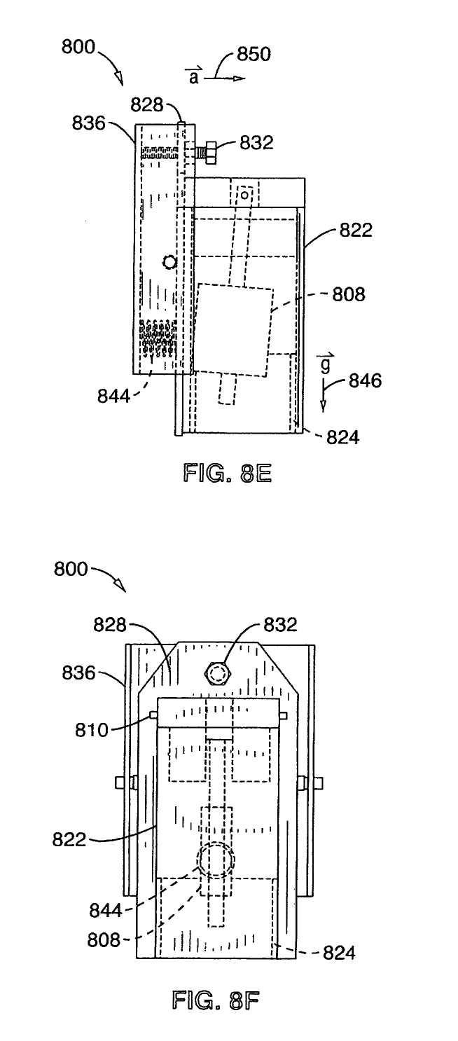

Refer now to FIGS. 8A, 8B, and 8C, which are exploded views of embodiments of an acceleration sensitive switch 800 in various states of exploded assembly. Here, a pendulum assembly 802 is comprised of a pendulum shaft 804 that has a closely toleranced press-fit through hole 806 passing through it. A pendulum weight 808 is attached to the pendulum shaft 804 to provide an actuation weight that overcomes friction present in the system during operation. A pendulum pivot shaft 810 is electrically connected through a mechanical connection (here shown as crimped clip contact 812, although direct soldering or welded attachment may also be used) to some input 814, here simply labeled as V⁺ to indicate that it is one electrical connection to the momentary switch formed by the acceleration sensitive switch 800. Currently the pendulum pivot shaft 810 is stainless steel of 1.58 mm diameter, and the pendulum hole 806 is 1.60 mm in diameter. These two relative diameters of the pendulum pivot shaft 810 and pendulum shaft hole 806 allows for pendulum pivot shaft 810 insertion into the pendulum shaft hole 806. This arrangement provides for low resistivity (good) electrical contact that can be further enhanced by silver lubricant. The plane of pendulum swing is substantially perpendicular to the pendulum pivot shaft 810. The pendulum shaft 804 is made up of ⅛ inch copper which is then nickel and rhodium plated to prevent oxidation.

Pendulum pivot shaft 810 is loosely passed through hole 816 in pivot cap 818, then pressed through the closely toleranced press-fit through hole 806 in the pendulum shaft 804 (nestled within slot 820 to allow for angular pivoting of the pendulum shaft 804 as assembled), then finally through a matching other side of the through hole 816 in pivot cap 818. In this construction, pivoting of the pendulum assembly 802 comprises a rotation substantially about the pivot shaft 810. When comprised of suitably conductive material, the pendulum pivot 810, the pendulum shaft 804, and the pendulum weight 808, electrically connects input 814 V⁺ to the pendulum weigh 808. Therefore, an input voltage V⁺ 814 is transmitted to the pendulum weight 808, at least in some part. Depending on the switch circuitry used elsewhere, the resistivity of the path from the input voltage V⁺ 814 to the pendulum weight 808 may be much higher than traditional conductors, say anywhere from 0.1 to 10⁷Ω, so long as the non-contact resistance remains higher in the overall acceleration sensitive switch 800.

The thus-far-assembled pendulum element is then slid within a square cross-sectioned pendulum support 822, which has a conductive cylindrical insert 824 electrically connected to an output voltage V⁻ 826. The square cross-sectioned pendulum support 822 is mounted on a pendulum base 828 that may pivot about support pivot 830 through adjustment of pendulum swing angle adjustment screw 832 as it threads through threaded fastener 834 affixed to pendulum base 828. The dimensions formed between the inner open dimension the square cross-sectioned pendulum support 822 and pivot cap 818 may be sufficiently close to enable a press-fit of the two, otherwise, an adhesive or other means of attachment may be used.

Clearly, pivot cap 818 would need to have a much higher resistance than the closed circuit completed through the contact of the conductive cylindrical insert 824 and the pendulum weight 808, thereby completing a connection between input voltage V⁺ 814 and output voltage V⁻ 826. Currently the pivot cap 818 is fabricated in an insulating plastic material. While these electrical connections have been arbitrarily called voltages, in reality they are switch closure contacts.

The clearance between the inner diameter of conductive cylindrical insert 824 and the pendulum weight 808 may be reduced sufficiently to enable sensitive detections of accelerations exceeding some small level. However, such reduction in clearance may produce difficulties where pendulum assembly 802 is mounted off of vertical, thereby incorrectly inducing a constantly closed switch. To correct for this situation, pendulum support 828 is rotationally mounted through support pivot 830 to pendulum base 836 through pendulum support pivot dowel 838 that passes through hole 840 to hole 842 in the pendulum base 836. Here, pendulum support pivot dowel 838 passes through the first hole 840, through support pivot 830, and finally through the second hole 842 in the pendulum base 832. Compression spring 844 offsets any adjustment in length of angle adjustment screw 832 as it presses against pendulum base 836 to form an adjustment set angle.

FIG. 8B is seen to be a partially assembled side view of the embodiment of FIG. 8A.

FIG. 8C is seen to be a fully assembled side view of the embodiment of FIG. 8A, with gravity 846 pointing down.

Refer now to FIG. 8D, which is a fully assembled side view of the embodiment of FIG. 8A, adjusted for mounting on a tilted surface. Here, the acceleration sensitive switch 800 has been sufficiently adjusted through advancement of the angle adjustment screw 832 as pressed against pendulum base 836 to form an adjustment set angle. The result is that the pendulum weight 808 hangs clear of the conductive cylindrical insert 824 as if the pendulum base 836 mounting surface 848 were vertical with respect to gravity 846.

Refer now to FIG. 8E, which is the fully assembled side view of the embodiment of FIG. 8C under an acceleration-initiated contact. It is seen that some lateral component of acceleration 850 has swung pendulum weight 808 into contact with the conductive cylindrical insert 824, thereby completing the momentary pendulum switch action.

Refer now to FIG. 8F, which is a fully assembled top view of the acceleration sensitive switch embodiment 800 of FIG. 8A.

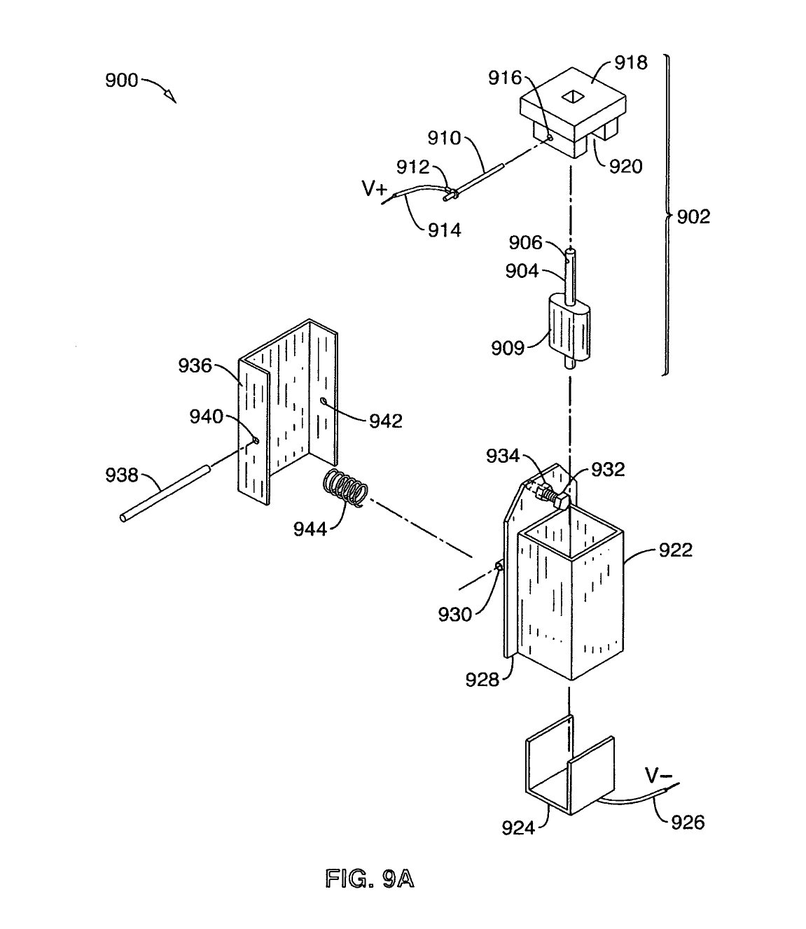

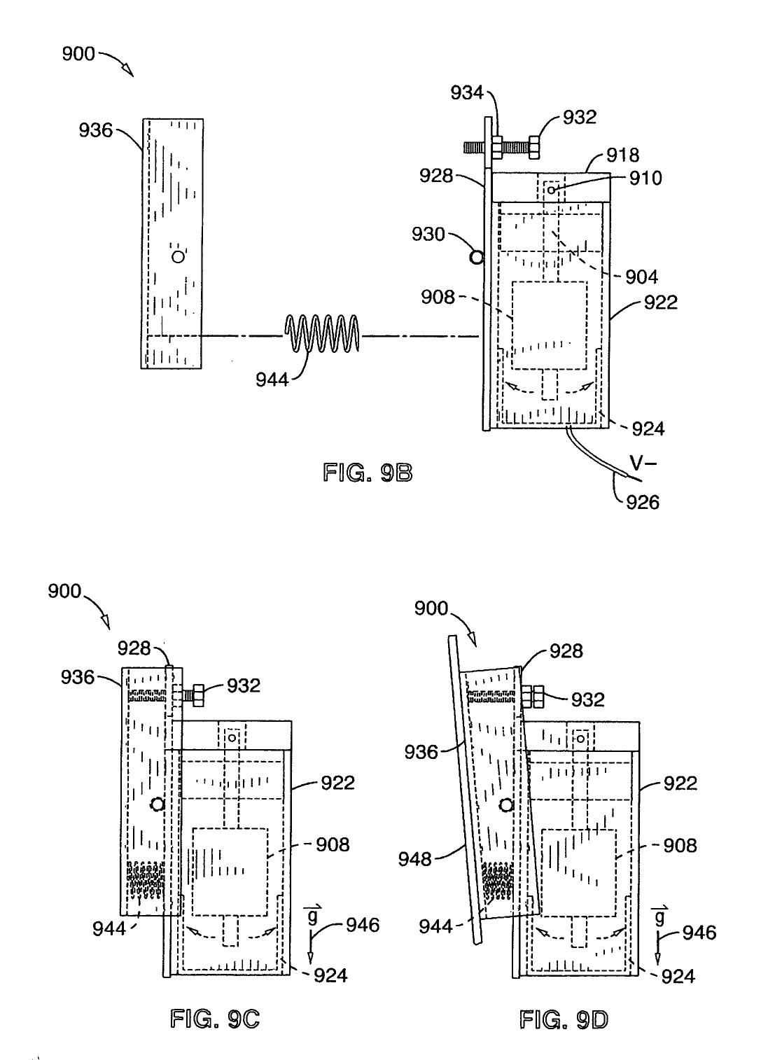

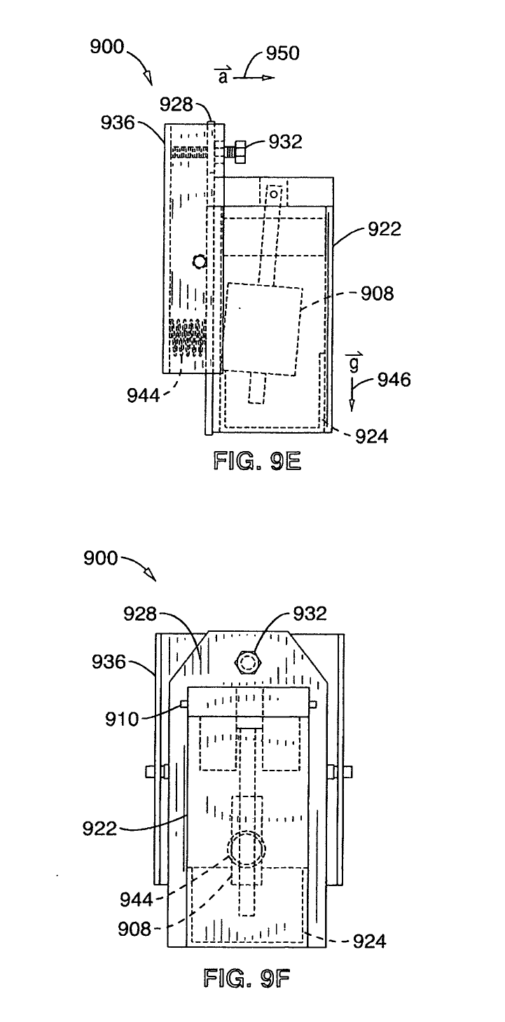

Refer now to FIGS. 9A, 9B, and 9C, which are exploded views of a second embodiment of an acceleration sensitive switch 900 in various states of exploded assembly. Here, a pendulum assembly 902 is comprised of a pendulum shaft 904 that has a closely toleranced press-fit through hole 906 passing through it. A pendulum weight 908 is attached to the pendulum shaft 904 to provide an actuation weight that overcomes friction present in the system during operation. A pendulum pivot shaft 910 is electrically connected through a mechanical connection (here shown as crimped clip contact 912, although direct soldering or welded attachment may also be used) to some input 914, here simply labeled as V⁺ to indicate that it is one electrical connection to the momentary switch formed by the acceleration sensitive switch 900. Currently the pendulum pivot shaft 910 is stainless steel of 1.58 mm diameter, and the pendulum hole 906 is 1.60 mm in diameter. These two relative diameters of the pendulum pivot shaft 910 and pendulum shaft hole 906 allows for pendulum pivot shaft 910 insertion into the pendulum shaft hole 906. This arrangement provides for low resistivity (good) electrical contact that can be further enhanced by silver lubricant. The plane of pendulum swing is substantially perpendicular to the pendulum pivot shaft 910. The pendulum shaft 904 is made up of ⅛ inch copper which is then nickel and rhodium plated to prevent oxidation.

Pendulum pivot shaft 910 is loosely passed through hole 916 in pivot cap 918, then pressed through the closely toleranced press-fit through hole 906 in the pendulum shaft 904 (nestled within slot 920 to allow for angular pivoting of the pendulum shaft 904 as assembled), then finally through a matching other side of the through hole 916 in pivot cap 918. In this construction, pivoting of the pendulum assembly 902 comprises a rotation substantially about the pivot shaft 910. When comprised of suitably conductive material, the pendulum pivot 910, the pendulum shaft 904, and the pendulum weight 908, electrically connects input 914 V⁺ to the pendulum weigh 908. Therefore, an input voltage V⁺ 914 is transmitted to the pendulum weight 908, at least in some part. Depending on the switch circuitry used elsewhere, the resistivity of the path from the input voltage V⁺ 914 to the pendulum weight 908 may be much higher than traditional conductors, say anywhere from 0.1 to 10⁷Ω, so long as the non-contact resistance remains higher in the overall acceleration sensitive switch 900.

The thus-far-assembled pendulum element is then slid within a square cross-sectioned pendulum support 922, which has a conductive u-shaped insert 924 electrically connected to an output voltage V⁻ 926. The square cross-sectioned pendulum support 922 is mounted on a pendulum base 928 that may pivot about support pivot 930 through adjustment of pendulum swing angle adjustment screw 932 as it threads through threaded fastener 934 affixed to pendulum base 928. The dimensions formed between the inner open dimension the square cross-sectioned pendulum support 922 and pivot cap 918 may be sufficiently close to enable a press-fit of the two, otherwise, an adhesive or other means of attachment may be used.

Clearly, pivot cap 918 would need to have a much higher resistance than the closed circuit completed through the contact of the conductive u-shaped insert 924 and the pendulum weight 908, thereby completing a connection between input voltage V⁺ 914 and output voltage V⁺ 926. Currently the pivot cap 918 is fabricated in an insulating plastic material. While these electrical connections have been arbitrarily called voltages, in reality they are switch closure contacts.

The clearance between the inner diameter of conductive u-shaped insert 924 and the pendulum weight 908 may be reduced sufficiently to enable sensitive detections of accelerations exceeding some small level. However, such reduction in clearance may produce difficulties where pendulum assembly 902 is mounted off of vertical, thereby incorrectly inducing a constantly closed switch. To correct for this situation, pendulum support 928 is rotationally mounted through support pivot 930 to pendulum base 936 through pendulum support pivot dowel 938 that passes through hole 940 to hole 942 in the pendulum base 936. Here, pendulum support pivot dowel 938 passes through the first hole 940, through support pivot 930, and finally through the second hole 942 in the pendulum base 932. Compression spring 944 offsets any adjustment in length of angle adjustment screw 932 as it presses against pendulum base 936 to form an adjustment set angle.

FIG. 9B is seen to be a partially assembled side view of the embodiment of FIG. 9A.

FIG. 9C is seen to be a fully assembled side view of the embodiment of FIG. 9A, with gravity 946 pointing down.

Refer now to FIG. 9D, which is a fully assembled side view of the embodiment of FIG. 9A, adjusted for mounting on a tilted surface. Here, the acceleration sensitive switch 900 has been sufficiently adjusted through advancement of the angle adjustment screw 932 as pressed against pendulum base 936 to form an adjustment set angle. The result is that the pendulum weight 908 hangs clear of the conductive u-shaped insert 924 as if the pendulum base 936 mounting surface 948 were vertical with respect to gravity 946.

Refer now to FIG. 9E, which is the fully assembled side view of the embodiment of FIG. 9C under an acceleration-initiated contact. It is seen that some lateral component of acceleration 950 has swung pendulum weight 908 into contact with the conductive u-shaped insert 924, thereby completing the momentary pendulum switch action.

Refer now to FIG. 9F, which is a fully assembled top view of the acceleration sensitive switch embodiment 900 of FIG. 9A.

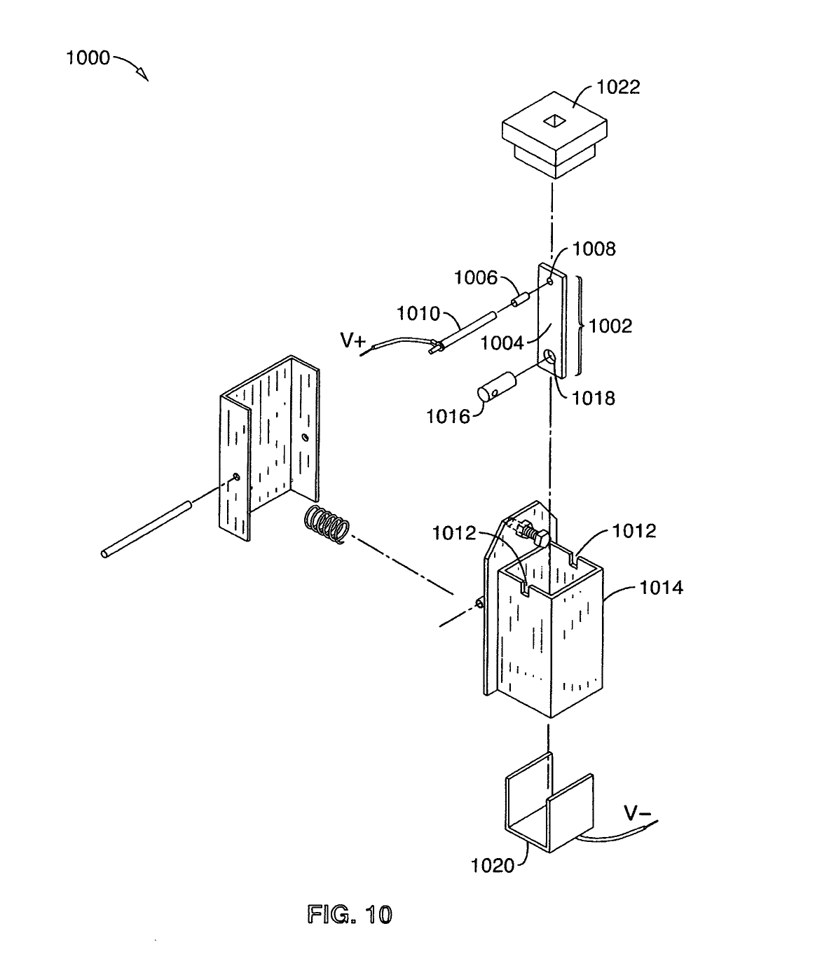

Refer now to FIG. 10, which is a view of yet another embodiment of an acceleration sensitive switch 1000 in various states of exploded assembly. Here, a pendulum assembly 1002 shows one embodiment where the pendulum shaft 1004 is a 1/32 inch plated copper strip with a pivot 1006 at the top of pendulum shaft 1004. The pivot 1006 is comprised of a plated ⅛ inch external diameter copper tube soldered through the top pivot hole 1008 to allow the 1/16 inch diameter stainless steel pivot 1010 to pass through the top pivot hole 1008 and rest, glued, in the notches 1012 of plastic square tube 1014.

A pendulum weight 1016 is comprised of a segment of 3/16 inch diameter copper rod soldered through a larger bottom hole 1018 in the pendulum shaft 1004. The pendulum shaft 1004 itself acts as the momentary contact conductor with a contact striker 1020. Pivot cap 1022 is then assembled onto the plastic square tube 1014 for sealing.

As the remaining details of FIG. 10 closely mirror the same details previously described in detail in the FIGS. 8A-8F and 9A-9F Figure set, they will not be duplicated here.

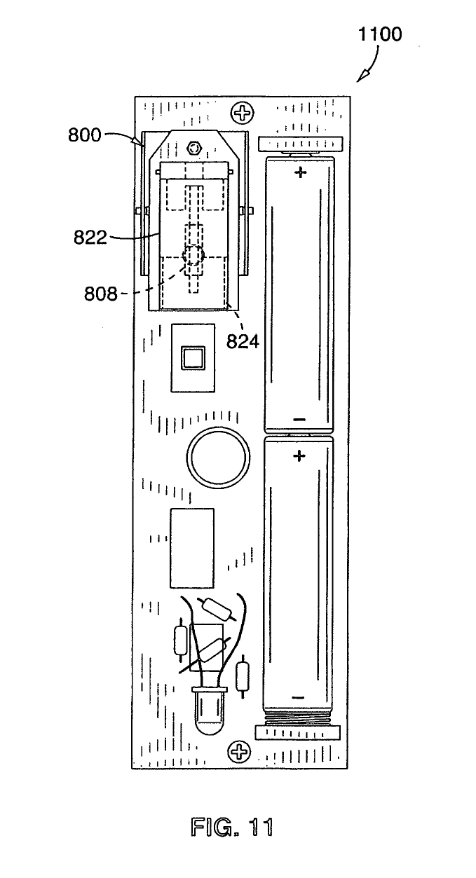

Refer now to FIG. 11, which shows a top view of one embodiment of the invention 1100 incorporating the acceleration sensitive switch 800 of FIG. 8A through FIG. 8F. Here, the acceleration sensitive switch 800 is but one of the circuit components previously described in the schematic of FIGS. 7A and 7B.

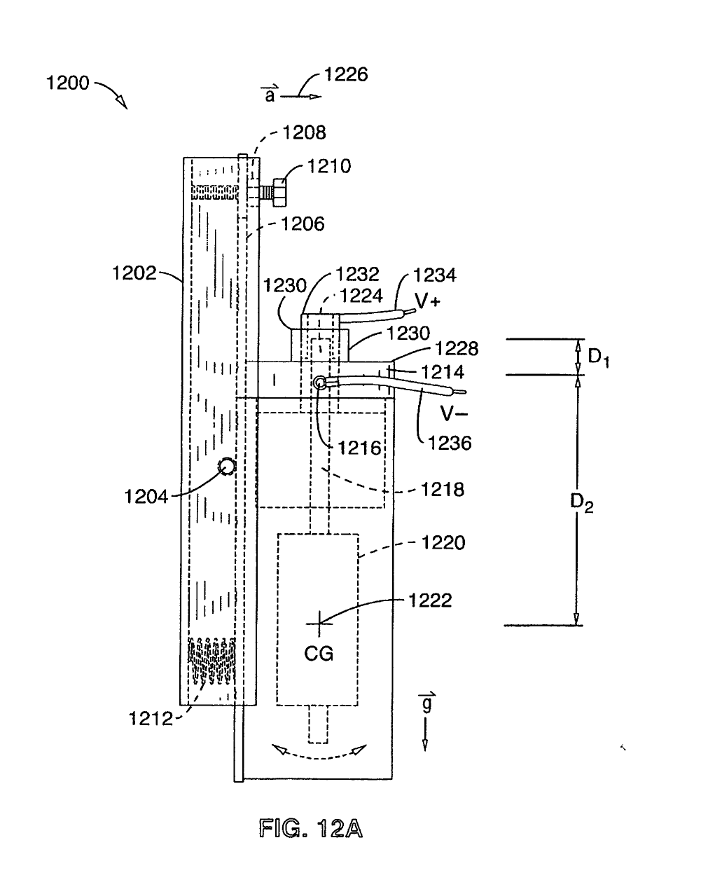

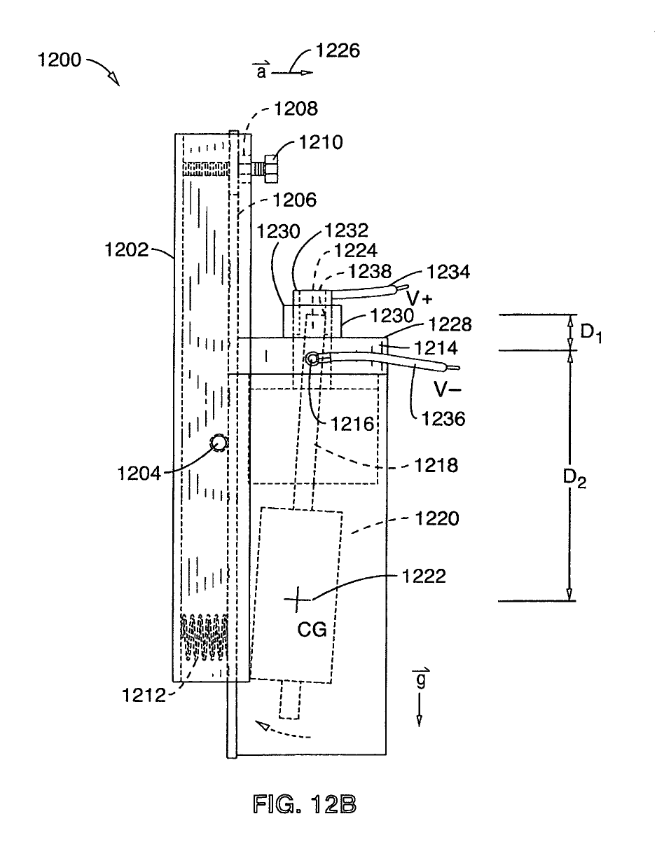

Refer now to FIG. 12A, which is a side view of an improved pendulum switch 1200. Here, a pendulum base 1202 has attached to it a pendulum support pivot dowel 1204 through which pendulum support 1206 is rotatably mounted. Pendulum support 1206 has its adjustment angle varied though threaded fastener 1208 affixed to the pendulum support 1206, with an angle adjustment screw 1210 threading in or out of the threaded fastener 1208 to vary the angle of rotation of the pendulum support 1206 relative to the pendulum base 1202. Compression spring 1212 provides spring loading of the adjustment screw 1210 threading through the threaded fastener 1208.

A modified pivot cap 1214 allows for passage of electrically conductive pendulum pivot 1216 through a pivot shaft 1218. The electrically conductive pivot shaft 1218 in turn has a weight 1220 attached to it with a center of gravity 1222. A top portion 1224 of the pivot shaft 1218 extends above the pendulum pivot 1216 forming a distance D₁. The distance from the pendulum pivot 1216 to the center of gravity 1222 of the weight 1220 forms a distance D₂. The ratio of D₂/D₁ forms a mechanical advantage, effectively multiplying an incident lateral acceleration 1226, with reduced travel of the top portion 1224 of the improved pendulum switch 1200.

To accommodate the reduced travel discussed above, from a top surface 1228 of the modified pivot cap 1214 extends a contact mount 1230, to which electrical contacts 1232 are attached. Since the contact mount 1230 may be injection molded simultaneously with the remainder of the modified pivot cap 1214, it may be made very accurately, with precise dimensions. The modified pivot cap would be a nonconductive plastic.

Electrical operation of the improved pendulum switch 1200 takes place through the low resistance closure of the top portion 1224 of the pendulum shaft 1218 to the electrical contact 1232 connected to a V⁺ output 1234, where the pendulum shaft 1218 is also electrically conductive. The pendulum shaft 1218 continues the circuit through the pendulum pivot 1216 to a V⁻ output 1236. During operation, the V⁺ output 1234 and the V⁻ output 1236 are electrically connected with a low impedance relative to their open state.

Refer now to FIG. 12B, which shows the improved pendulum switch 1200 in its closed position at contact point 1228. Here, lateral acceleration 1226 has caused a rotation of pendulum shaft 1218, weight 1220, and top portion 1224 of the pivot shaft 1218, to pivot about pendulum pivot 1216. In this manner, the top portion 1224 makes contact with electrical contacts 1232, thereby closing the switch.

The improved pendulum switch 1200 shown previously in FIGS. 12A and 12B may be designed to either increase sensitivity of the switch to lateral accelerations 1226, or to exhibit decreased contact resistance due to force amplification of the of D₂/D₁ mechanical advantage. Typical, but not limiting, values of such a switch are D₂=4 mm and D₁=0.5 mm, forming a mechanical advantage of 8:1. For a weight of 1 gram (typically using Pb or Cu for the weight), then the effective contact closure force would be 8 grams. With the improved pendulum switch, the overall length of the switch may readily be reduced to about 9 mm.

Further, since the weighted portion of the switch is no longer making electrical contact, the improved pendulum switch may be made far thinner than the previous embodiment of the pendulum switch.

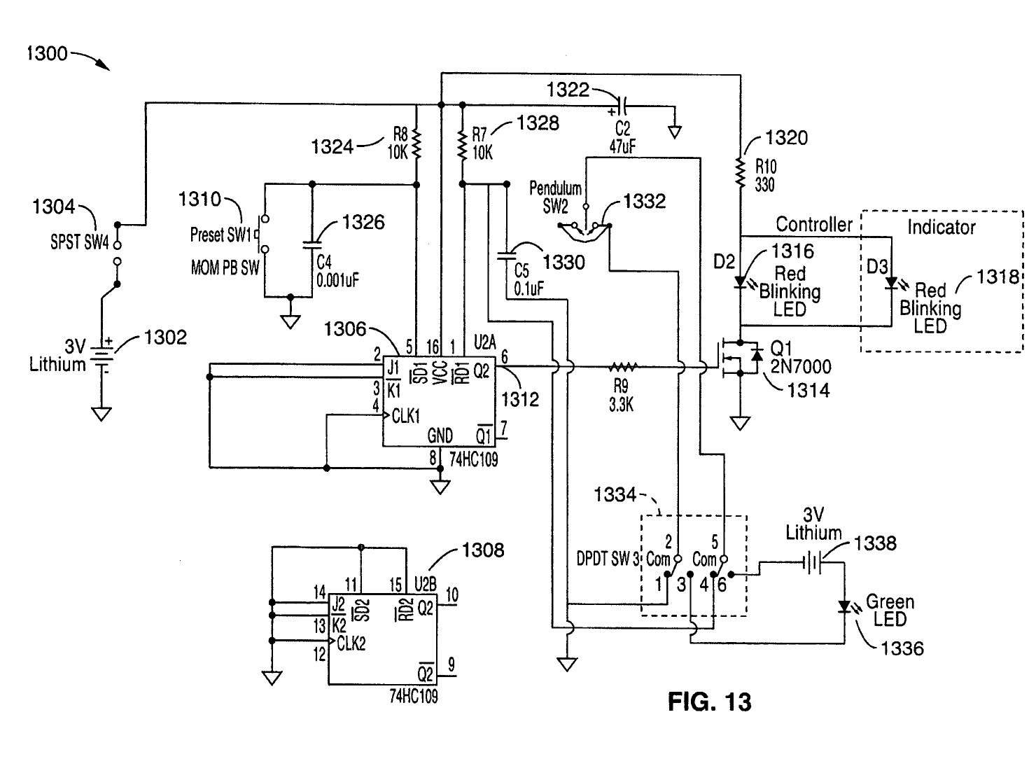

Refer now to FIG. 13, which is a schematic of a circuit 1300 used in the pendulum style privacy indicator. This schematic represents the use of a solid state latching mechanism with the vertical adjustment circuit 730 previously shown in FIG. 7B. Here a nominal 3 V battery 1302 supplies power to the circuit when SPST switch SW4 1304 is switched on. A first side 1306 of a dual J K̅ flip flop (typically a 74HC109 CMOS device) is predominantly used to control this circuit. The second side 1308 of the dual J K̅ flip flop is not used at this point, but can be used as an oscillating circuit to flash the indicator LEDs 1316, 1318.

Momentary switch 1310 grounds pin 5, the SET input (SD1), of the J K̅ flip flop 1306 which toggles on the output 1312 to the LEDS. The output 1312 of the first side 1306 of the dual J K̅ (commonly referred to as simply JK) flip flop controls the gate of an n-channel MOSFET 1314, which in turns allows for one or more LEDs 1316, 1318 to be driven as needed. To prevent overdriving the LEDs 1316 and 1318, a current limiting resistor 1320 is used. Bypass capacitor C21322 10K resistor R8 1324 and 0.001 g capacitor C4 1326 are used to debounce the momentary switch 1310. Similarly, 10K resistor R7 1328 and 0.1 μF capacitor 1330 C5 are used to debounce the pendulum switch 1332.

The pendulum switch 1332 momentarily closes contact as the door is opened and grounds pin 1, the RESET or CLEAR input (RD1) of the JK flip flop 1306, which toggles off the output 1312 to the LEDS 1316 and 1318. The output 1312 remains off until the momentary switch 1310 is pushed, momentarily closing and grounding pin 5 of the J K̅ flip flop 1306 which toggles on the output to the LEDS.DPDT switch 1334 has the same function in this circuit as switch 732 did in circuit 730 previously discussed in FIG. 7B. That function is to connect the pendulum switch 1332 to either the controller circuit, or the vertical adjustment circuit depending upon which direction the switch is thrown.

As previously described, this alignment circuit is used initially to adjust the pendulum switch 1332 to local vertical. Thereafter, DPDT switch 1334 is reset to the state of normal operation of the improved privacy indicator and alignment device 1300, where LEDs 1316 and 1318 blink to indicate occupancy, and are turned off via either sufficient movement of the pendulum switch 1332 (until contact within the switch is made), or by again pressing the momentary switch 1310.

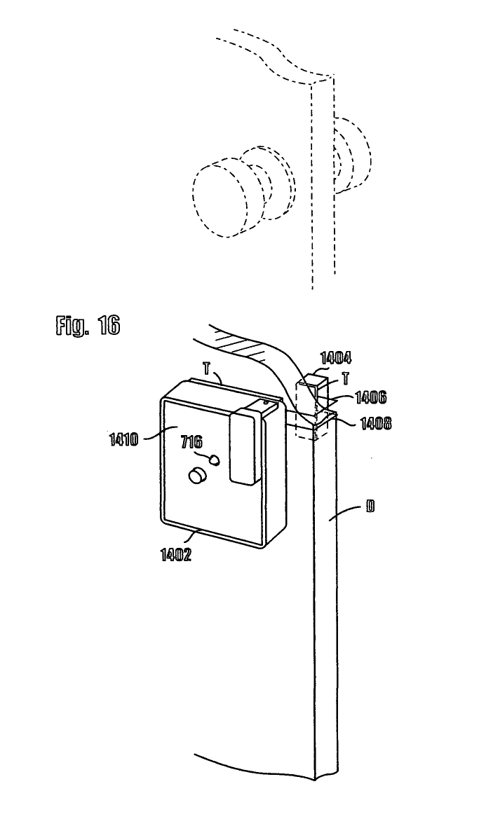

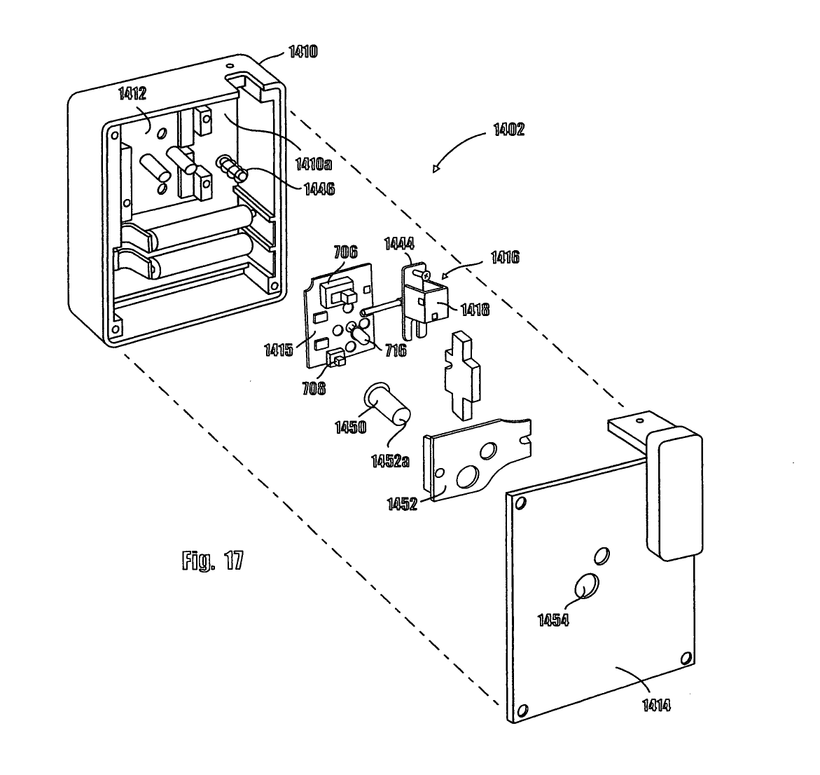

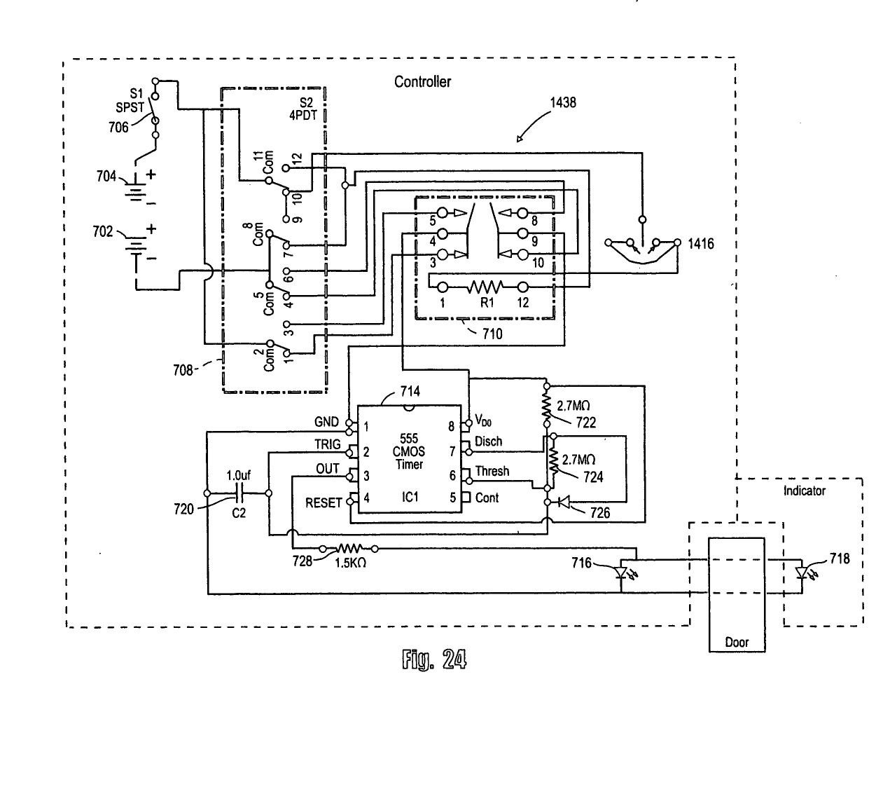

Turning now to FIGS. 14 through 26, still another form of the privacy indicator apparatus of the invention is there shown and generally designated by the numeral 1400. This latest apparatus is similar in some respects to the apparatus illustrated in FIGS. 1 through 13 and like numerals are used in FIGS. 14 through 25 to identify like components. As in the earlier described embodiments of the invention, privacy indicator apparatus 1400 comprises a controller 1402 that is operably interconnected with an indicator 1404. Controller 1402 is removably mounted in any suitable manner, such as by double-sided tape “T”, to one side of a swinging door “D” and indicator 1404 is removably mounted to the opposite side of the door in any suitable manner, such as by double-sided tape “T” (see FIGS. 14 through 16). In this embodiment, the controller is mounted on the side of the door facing the area wherein the user desires privacy. Controller 1402 and indicator 1404 are electrically inter-connected by conductors, here shown as thin wires 1406 and 1408 that wrap around the edge of the door. As best seen by referring to FIG. 17, the important controller 1402 of the apparatus here comprises a controller housing 1410 that has an internal controller chamber 1412 and includes a removable cover 1414. Disposed within controller internal controller chamber 1412 is an electrical circuit board 1415 and a novel motion detector assembly 1416 that, in a manner presently to be described, functions to detect movement of the door “D” as it is opened and closed by the user. Motion detector 1416 includes a detector housing 1418 that is preferably constructed from a non-electrically conductive material, such as plastic. Detector housing 1418 has an internal detector chamber 1418a having a substantially transparent top viewing window 1419 (FIGS. 18 and 18A). Mounted within the detector chamber is an electrically conductive, uniquely configured base 1422.

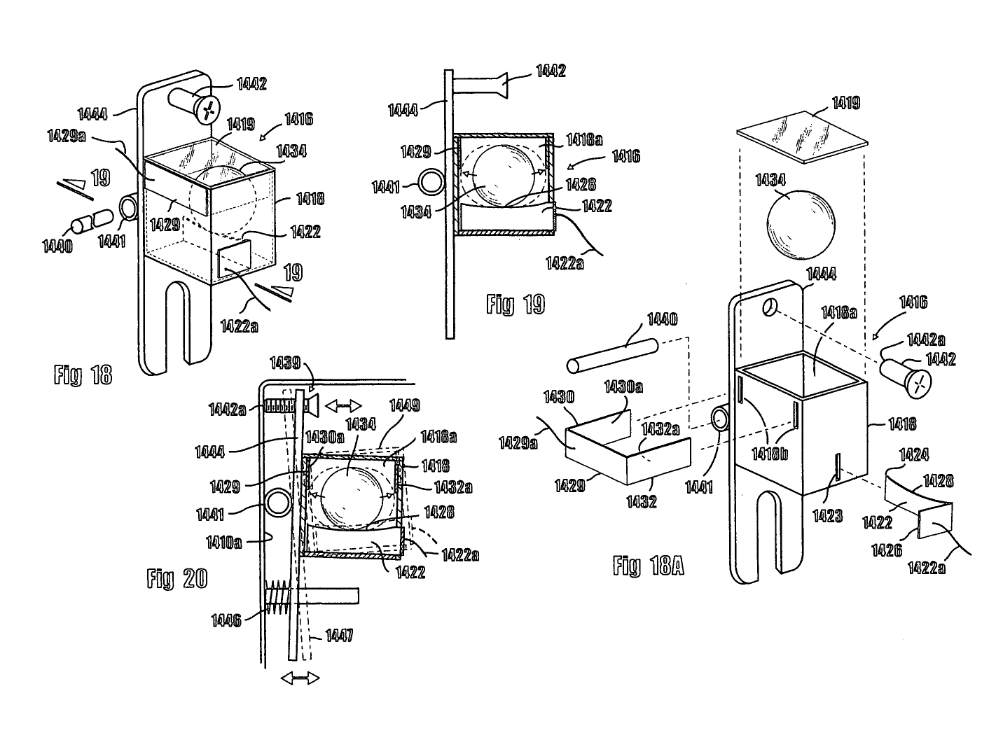

Base 1422, which is receivable within an opening 1423 formed in the side wall of the detector chamber (FIG. 18), has first and second spaced apart ends 1424 and 1426 and a central concave surface 1428. End 1426 is bent over to form a connection surface for a thin wire connector 1422a that electrically interconnects base 1422 with circuit board 1415 (see FIGS. 18 and 19). Base 1422 can be formed from various electrically conductive metals such as copper.

Also partially disposed within internal chamber 1418a of detector housing 1418 is a generally “U”-shaped electrical conductor 1429. Conductor 1429 has a first conductive end portion 1430 having a substantially planar surface 1430a that is disposed within internal chamber 1418a and a second conductive end portion 1432 having a substantially planar surface 1432a that is disposed within internal chamber 1418a. Conductor 1429 is operably interconnected with the electrical circuit board by a thin wire 1429a (FIGS. 18 and 18A).

A novel and highly important feature of the motion detector 1416 of this latest form of the invention is a specially constructed, generally spherical member 1434 that is disposed in rolling engagement with the concave surface 1428 of base 1422. While member 1434 can be constructed from various electrically conductive materials, it is here provided in the form of a brass sphere that has been uniformly covered with thin, nickel plating. As will be discussed in greater detail hereinafter, the spherical member 1434 is movable in response to the opening and closing of the door along the concave surface 1428. More particularly, when the door is in an open, at rest position, the spherical member will reside in a first central position as shown by the solid lines in FIG. 19. As the door is moved, the spherical member can move between a central position and a second position, wherein it is in engagement with surface 1430a of the first conductive portion 1430 of the conductor 1429 and also can move between its central position and a third position wherein the spherical member is in engagement with surface 1432a of the second conductive portion 1432 of the conductor 1429. It is to be appreciated that the sensitivity of the device can be optimized for a particular use by varying the degree of concavity of the surface 1428 of the base to thereby control rolling characteristics of the spherical member along the concave surface.

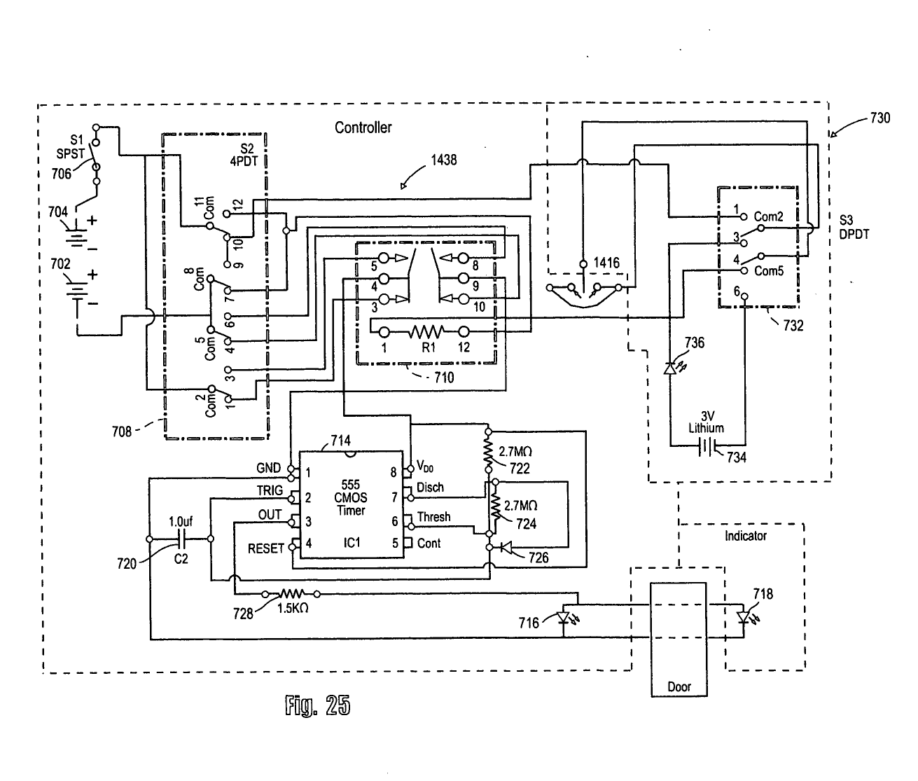

Electrical circuit board 1415 includes an electrical circuit 1438 (FIG. 24) that is operably associated with controller 1402 and indicator 1404. As depicted in FIG. 24, which is a schematic of electrical circuit 1438, this circuit is similar in many respects to the circuit previously described herein and like numerals are used in FIG. 24 to identify like components. However, circuit 1438 here includes the new and novel motion detector 1416, the character of which is illustrated in greater detail in FIGS. 18 through 20 of the drawings.

Referring to FIG. 24, as before, circuit 1438 includes two batteries 702 and 704 that are placed in series to provide power to the circuit. The batteries 702 and 704 would likely be alkaline cells, although other batteries combining to produce an output voltage from 2.8-3.5 volts would also be acceptable. Additionally, with circuitry redesign for other voltages, still other battery supplies could be used. The batteries 702 and 704 are switched by S1, a single pole single throw (SPST) switch 706 that operates to disconnect the batteries 702 and 704 from periods of nonuse. Such periods of nonuse would include when the portable privacy indicating unit is being stored in a drawer. S2 is a push-button 4 pole double throw (4PDT) switch 708 that in one state resets the privacy indication “off”, and in the other state initiates a privacy indication of “in use”. 4 pole double throw switch 708, when triggering the “in use” state, energizes R1, the single coil latching relay 710 to set the “in use” state. Conversely, release of the 4PDT switch 708 resets the single coil latching relay 710 to an “off” state. The “in use” state may be cancelled by turning off S1, the SPST switch 706 for main power, or by switching “off” the 4PDT switch 708. Finally, the “in use” state may be cancelled by a momentary connection of the motion detector switch 1416, which operates to reset the single coil latching relay 710 to the “off” state.

While the “in use” state is active, IC1, typically a CMOS 555 timer 714 operates to control the “blinking” of output light emitting diodes (LEDs) 716 and 718. Alternatively, the LEDs 716 and 718 may have a built-in integrated flashing mechanism, where the CMOS 555 timer 714 is used to modulate the blinking and conserve power. Typically, one of these LEDs is present in the controller unit and another in the indicator unit. The rate of “blinking”, and consequent power consumption, is controlled by C2, a 1 μF capacitor 720, resistors 722 and 724 that are 2.7 MΩ, and diode 726. The current supplied to LEDs 716 and 718 is limited by a 1.5 kΩ resistor 728. The specifications of the aforementioned components are used with a self-flashing LED with an internal integrated circuit for blinking. The CMOS 555 timer 714 is used to conserve power by switching off the LEDs 716 and 718. The battery life of two 1.5V Alkaline batteries 702 and 704 in series is calculated to power continuous “in use” blinking for at least 3 months, and has been tested to last at least 5 months. Intermittent “in use” usage at 20% to 50% is calculated to extend battery life to greater than one year.

To further elucidate, the “in use” state and its cancellation are controlled by a 4PDT switch 708, a single coil 2PDT latching relay 710, and a single direct current power source (comprising batteries 702 and 704). One side of the 4PDT switch 708 controls alternating polarity to the single coil 2PDT latching relay 710 coil (indicated as a resistor between pins 1 and 12) through the motion detector switch 1416.

The power contacts in the latching relay are supplied alternately from one or the other side (throw) of the 4PDT switch 708. When SPST switch 706 is closed as normally used, the power from the batteries 702 and 704 is transmitted respectively to the positive common contacts 11 and 2, and the negative common contacts 5 and 8 of the 4PDT switch 708. The four output contacts of the 4PDTswitch 708 (contacts 1, 3, 4, and 6) on the side assigned to current passing, to the power contacts of a 2PDT latching relay 710, are arranged (contacts 1 and 3 positive) and (contacts 4 and 6 negative). When the 4PDT switch 708 is switched in one direction, contacts 1 and 4 are closed, thereby passing current respectively to contacts 3 and 10 on the 2PDT latching relay 710.

When the 4PDT switch 708 is switched in the alternate sense, contacts 4 and 6 are closed, while contacts 1 and 3 are opened, and current now passes from contacts 4 and 6 respectively to contacts 5 and 8 on the 2PDT latching relay 710.

Whether the power current flowing through the 4PDT 708 to the 2PDT single coil latching relay 710 results in a “in use” state, depends on whether the 2PDT single coil latching relay 710 is latched in the direction to allow current to pass from contacts 5 and 8 (respectively out through contacts 4 and 9), or latched in the direction to allow current to pass from contacts 3 and 10 (respectively out through contacts 4 and 9) to the CMOS 555 timer 714 “blinking” LED circuit. The state of latching in the 2PDT single coil latching relay 710 depends on the polarity of coil R1 contacts 1 and 12 faced at the last motion detector switch 1416 position.

Assume FIG. 24 represents an “in use” state of the circuit so that current is passed from contacts 1 and 4 on the 4PDT switch 708 to respective contacts 3 and 10 on the 2PDT single coil latching relay 710. Therefore, the 2PDT single coil latching relay 710 is latched so that positive power contacts 3 and 4 are closed, and negative power contacts 10 and 9 are closed, thereby allowing current to pass to CMOS 555 circuit 714. Notice that the coil R1 contact 12 is connected to the 4PDT switch 708 negative contact 8, and R1 contact 1 is potentially connected to 4PDT switch 708 positive contact 11. If the motion detector switch 1416 momentarily closes, then the actual current will flow to the coil R1 and the 2PDT latching relay 710 will latch in the opposite direction so positive contacts 3 and 4 will open and contacts 4 and 5 will close, and negative contacts 10 and 9 will open and contacts 9 and 8 will close.

Since there is no power passing from the 4PDT switch 708 to contacts 5 and 8 on the 2PDT latching relay 710, the circuit goes into a cancelled “in use” state until the 4PDT switch 708 is thrown to the alternate switch position, after which contact 3 (positive) and contact 6 (negative) on the 4PDT switch 710 become closed, and thereby pass current to respective contacts 5 and 8 on the 2PDT latching relay 710, which, in this scenario through the motion detector switch 1416, have been previously latched to output contacts 4 and 9, thus supplying power to the CMOS 555 timer 714 circuit and reactivating an “in use” blinking state.

Note from FIG. 24 that when the 4PDTswitch 708 is thrown to the alternate position, positive contact 11 through contact 12 on the 4PDT switch 708 will be connected to contact 12 on the 2PDT single coil latching relay 210, and negative contact 8 through contact 9 on the 4PDT switch 708 will be connected through the open the motion detector switch 1416 to contact 1 on the 2PDT single coil latching relay 710. This then establishes a possible reverse of polarity to the single coil R1, which will become an actual current once the motion detector switch 1416 momentarily closes and creates an alternative latching and a canceled “in use” state.

The general principle to be observed in connecting the 4PDT switch 708 with the 2PDT single coil latching relay 710 is that the power output contacts of the 4PDT switch 708 passing to the power input contacts on the 2PDT single coil latching relay 710 creating an “in use” state, should, simultaneously in the same throw, carry to the single coil R1 the reverse polarity of current which when activated by the motion detector switch will latch to the side of the 2PDT single coil latching relay 710, which will open the circuit creating the cancelled “in use” state.

In the “in use” state, where the CMOS 555 timer 714 “blinking” LED circuit is active continues until either the 4PDT switch 708 is thrown in the opposite direction removing power to the active side of the single coil 2PDT latching relay 710, and reversing the potential R1 coil polarity coming out of the 4PDT switch 708 to the same polarity that sustains the current latched state so that if the motion detector switch now closes the current “cancelled” state remains until the 4PDT switch 208 is thrown back to the original “in use” state; after which the potential R1 coil polarity from the 4PDT switch 208 is set back to the potential reverse latching” canceling” state if the motion detector switch 1416 is momentarily closed.

The closure of the motion detector switch now carries the opposite polarity, which reverses the current supplied to the single coil 2PDT latching relay 710 driver coil between pins 1 and 10 and, thereby, throws the latching mechanism with the single coil 2PDT latching relay 710 to the side of the single coil 2PDT latching relay 710, which is now opened and thereby breaks the power supply to the CMOS 555 timer 714 “blinking” LED circuit until the 4PDT switch 708 is reversed again.

The state of latching in the 2PDT single coil latching relay 710 depends on the polarity of coil R1 contacts 1 and 12 faced at the last motion detector switch momentary closure.

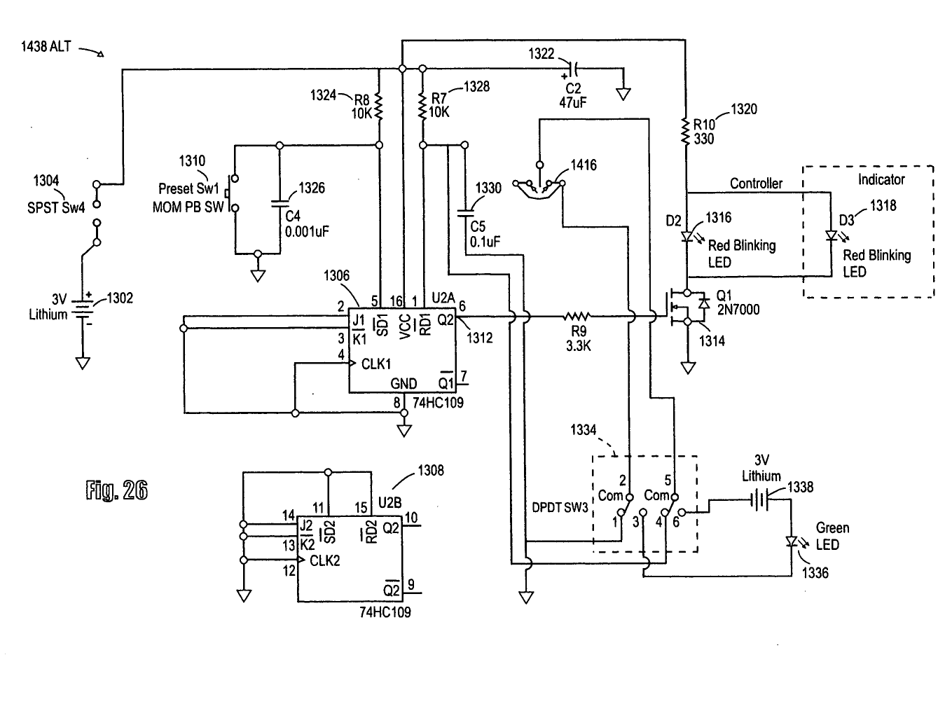

Refer now to FIG. 25, which is the circuit 1438 of FIG. 24 with a vertical adjustment circuit 730 added. Here, the vertical adjustment circuit 730 connects to the motion detector switch 1416 through a double pole double throw switch, DPDT SW3, 732. Note that the motion detector switch 1416 is connected to the common pins 2 and 5 of switch 732. Note that when the switch 732 is thrown connecting the common pins 2 and 5 to pins 1 and 4 respectively, the motion detector switch 1416 is part of the controller circuit 1438.

When the switch 732 is thrown in the direction of pins 3 and 6, the motion detector switch 1416 is disconnected from the controller circuit, and is part of the vertical adjustment circuit 730. The 730 circuit has its separate power supply 734 (3V lithium battery) and LED indicator 736 remains lit so long as the motion detector switch contacts are closed. Once the motion detector component adjustment (to be described later) is completed, and the motion detector switch 1416 rests in a stable nonconductive open state, the indicator LED 736 is no longer lit. The motion detector switch 1416 can now be thrown back connecting the common pins 2 and 5 to pins 1 and 4, thus disconnecting the motion detector switch 1416 from the adjustment circuit 730 and reconnecting it to the controller circuit.

In an alternate form of this latest embodiment of the invention, the electrical circuit board includes an alternate electrical circuit of the character shown in FIG. 26 and designated as 1438ALT. This circuit, which is similar to the previously described circuit depicted in FIG. 13 of the drawings, is operably associated with controller 1402 and indicator 1404. As depicted in FIG. 26, which is a schematic of electrical circuit 1438ALT, this circuit is similar in many respects to the circuit 300 previously described herein and like numerals are used in FIG. 24 to identify like components. However, circuit 1438ALT here includes the new and novel motion detector 1416, the character of which is illustrated in greater detail in FIGS. 18 through 20 of the drawings. FIG. 26 depicts the use of a solid state latching mechanism with an adjustment circuit 730 of the character shown in FIG. 7B. Here a nominal 3 V battery 1302 supplies power to the circuit when SPST switch SW4 1304 is switched on. A first side 1306 of a dual J K̅ flip flop (typically a 74HC 109 CMOS device) is predominantly used to control this circuit. The second side 1308 of the dual J K̅ flip flop is not used at this point, but can be used as an oscillating circuit to flash the indicator LEDs 1316, 1318.

Momentary switch 1310 grounds pin 5, the SET input (SD1), of the J K̅flip flop 1306 which toggles on the output 1312 to the LEDS. The output 1312 of the first side 1306 of the dual J K̅ (commonly referred to as simply JK) flip flop controls the gate of an n-channel MOSFET 1314, which in turns allows for one or more LEDs 1316, 1318 to be driven as needed. To prevent overdriving the LEDs 1316 and 1318, a current limiting resistor 1320 is used. Bypass capacitor C2 1322 10K resistor R8 1324 and 0.001 μF capacitor C4 1326 are used to debounce the momentary switch 1310. Similarly, 10K resistor R7 1328 and 0.1 μF capacitor 1330 C5 are used to debounce the motion detector switch 1416.

The motion detector switch 1416 momentarily closes contact as the door is opened and grounds pin 1, the RESET or CLEAR input (RD1) of the J K̅ flip flop 1306, which toggles off the output 1312 to the LEDS 1316 and 1318. The output 1312 remains off until the momentary switch 1310 is pushed, momentarily closing and grounding pin 5 of the J K̅ flip flop 1306 which toggles on the output to the LEDS.DPDT switch 1334 has the same function in this circuit as switch 732 did in circuit 730 previously discussed in FIG. 7B. That function is to connect the motion detector 1416 to either the controller circuit, or the adjustment circuit depending upon which direction the switch is thrown. As previously described, this alignment circuit is used initially to adjust the motion detector switch 1416 to a level condition. Thereafter, DPDT switch 1334 is reset to the state of normal operation of the improved privacy indicator and alignment device 1300, where LEDs 1316 and 1318 blink to indicate occupancy, and are turned off via either sufficient movement of the motion detector switch 1416 (until contact within the switch is made), or by again pressing the momentary switch 1310.

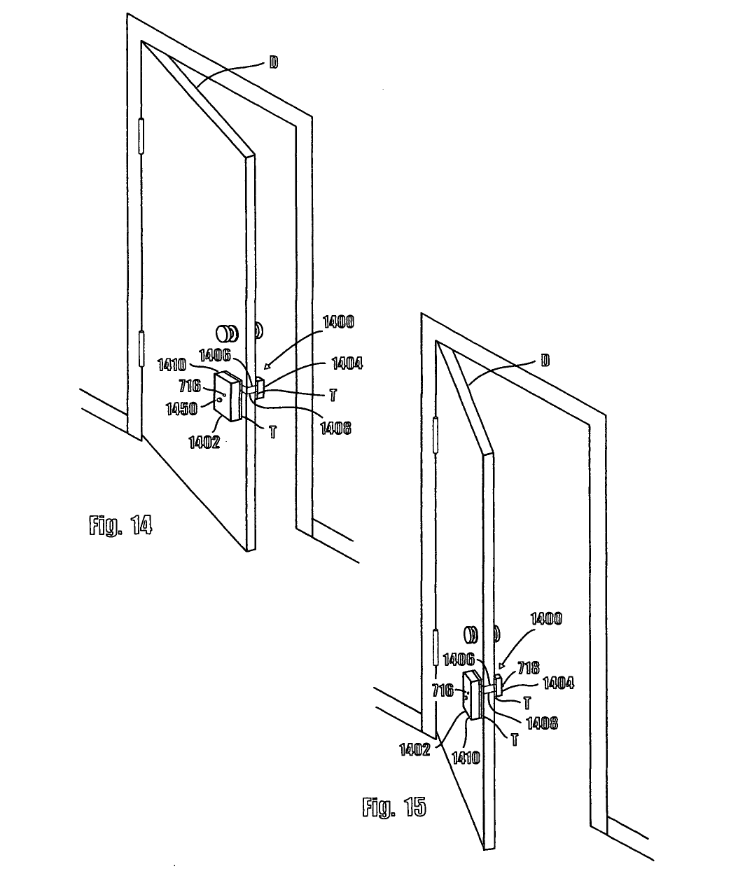

Considering now one form of the method of use of the apparatus of this latest form of the invention, after the controller and indicator units have been attached to the door in the manner illustrated in FIGS. 14 and 15, and switch 706 has been opened by the user, it may be necessary to use the adjustment mechanism 1439 (FIG. 20) of the invention to level the base 1422 of the motion detector 1416 so as to center the ball 1434 on the curved surface 1428. Access to the adjustment mechanism 1439 is achieved by removal of the housing cover 1414. As shown in FIGS. 17, 18 and 20, the motion detector unit is mounted to the rear wall 1410a of housing 1410 for pivotal movement about a transversely extending pivot rod 1440. As shown in FIGS. 18 and 20, the pivot rod is rotatably received within a bearing 1441 that is attached to the rear wall 1410a. An adjustment screw 1442 is threadably connected to a support member 1444, which is attached to bearing 1441. Housing 1418 of the motion detector is, in turn, connected to support member 1444. With this construction, because the inboard end 1442a of the spring engages the rear wall of housing 1410, rotation of the screw relative to support member 1444 will cause pivotal movement of the support member against the urging of a biasing spring 1446 in the manner indicated by the dotted lines 1447 of FIG. 20. This pivotal movement of the support member will raise or lower the housing 1418 in the manner indicated by the dotted lines 1449, which will, in turn, controllably change the level of base 1422.

When the base 1422 is level so that the ball 1434 will remain in the center of the curved base when the door is in an open, stationary position, the cover 1414 can be replaced. This done, the controller 1402 can be placed into an operable state by the user, pushing an actuating button 1450 that operates the previously identified switch 708 (FIG. 17). Actuating button 1450, which is mounted within housing 1410 by a bracket 1452, has an accessible end portion 1452a that extends through an opening 1454 provided in cover 1414.

Once the door is closed, the user places the controller in an operable state by pushing an actuating button 1450. In its operable state, the controller remains latched and the light emitting diodes (LEDs) 716 and 718 provided on the controller and the indicator units will blink (see FIGS. 14 and 15). However, upon the occupant opening, or reclosing the door, the spherical member 1434 will move from its first central position toward its second position wherein it engages the first conductive surface 1430a. Upon engaging conductive surface 1430a, the light emitting diodes (LEDs) 716 and 718 will shut off and stop blinking. When the door comes to rest, the spherical member will return to its central position and the lights will remain off until the latched state is reversed by pushing the 4PDT switch in the electromechanical circuit, or by pushing the momentary switch in the solid state circuit.

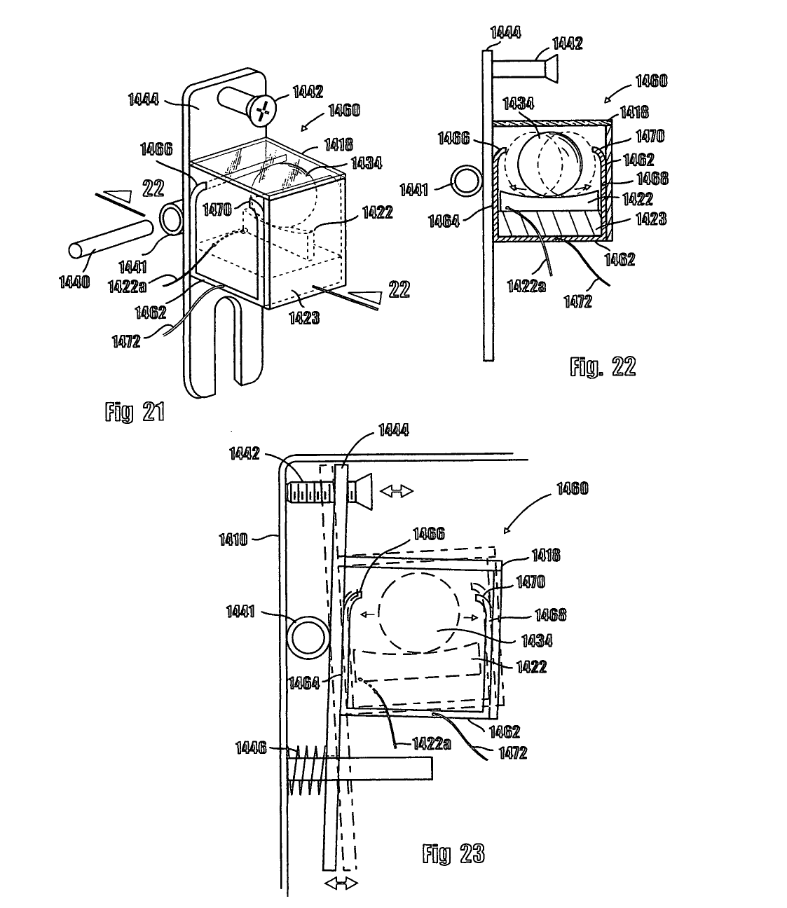

Referring now to FIGS. 21 through 23, an alternate form of the motion detector unit of the invention is there shown and generally designated by the numeral 1460. This unit is similar in many respects to the unit shown in FIGS. 18 through 20 and like numerals are used in FIGS. 21 through 23 to identify like components. The principal difference between this latest form of the motion detector and the earlier described motion detector resides in the configuration of the generally “U”-shaped electrical conductor 1462 that is housed within detector housing 1418 proximate base 1422. Conductor 1462 has a first generally vertically extending portion 1464 having an inwardly extending first spherical member engaging conductive finger 1466 and a second generally vertically extending conductive portion 1468 having an inwardly extending second spherical member engaging conductive finger 1470. As before, conductor 1462 is operably interconnected with the electrical circuit board by a thin wire 1472 (FIGS. 21 and 22).

In using this latest form of the apparatus of the invention, after the controller and indicator units have been attached to the door in the manner illustrated in FIGS. 14 and 15 and, if necessary, the base 1422 of the motion detector has been leveled in the manner previously described, the controller can be placed into an operable state by the user pushing an actuating button 1450 that operates the switch 708.

After closing the door and placing the controller in an operable state, the controller remains latched in this state and the light emitting diodes (LEDs) 716 and 718 provided on the controller and the indicator units will blink (see FIGS. 14 and 15). However, upon the occupant opening the door, the spherical member 1434 will move from its first central position toward its second position wherein it engages the inwardly extending first conductive finger 1466. Upon engaging finger 1466, the light emitting diodes (LEDs) 716 and 718 will stop blinking so as to indicate that the “at rest” state has been achieved. When the door comes to rest, the spherical member will return to its central position and the lights will remain off until the latched state is reversed by pushing the 4PDT switch in the electromechanical circuit, or by pushing the momentary switch in the solid state circuit.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. A privacy indicator apparatus for inter-connection with a door comprising a controller and an indicator connected to the door, said controller including a motion detector for detecting movement of the door, said motion detector comprising:
(a) a detector housing having an internal chamber;
(b) an electrically conductive base mounted within said internal chamber of said housing, said base having a concave surface;
(c) an electrical conductor mounted within said internal chamber of said housing proximate said electrically conductive base, said electrical connector having first and second spaced apart conductive portions; and
(d) a spherical member disposed in rolling engagement with said concave surface of said base, said spherical member being movable along said concave surface between a first central position, a second position in engagement with said first conductive portion of said electrical conductor and a third position in engagement with said second conductive portion of said electrical conductor.

2. The privacy indicator as defined in claim 1 in which said spherical member comprises a brass sphere plated with nickel.

3. The privacy indicator as defined in claim 1 in which said base is constructed from an electrically conductive metal.

4. The privacy indicator as defined in claim 1 in which said detector housing is constructed from a non-electrically conductive material.

5. The privacy indicator as defined in claim 1 in which said detector housing includes a substantially transparent top viewing window.

6. The privacy indicator as defined in claim 1 in which said first and second conductive portions of said motion detector include inwardly extending, spherical member engaging fingers.

7. The privacy indicator as defined in claim 1 in which said controller further includes an electrical circuit operably associated with said motion detector and a controller light emitting diode connected to said electrical circuit.

8. The privacy indicator as defined in claim 7 in which said indicator comprises an indicator light emitting diode operably associated with said electrical circuit.

9. The privacy indicator as defined in claim 6 in which said electrical circuit comprises a battery operably associated with said controller light emitting diode to provide power thereto; a single pole single throw switch connected to said battery; and a push button four pole double throw switch operably associated with said controller light emitting diode.

10. A privacy indicator apparatus comprising:
(a) a controller including:
(i) a controller housing having an internal controller chamber;
(ii) an electrical circuit board disposed within said internal controller chamber;
(iii) a motion detector disposed within said internal controller chamber, said motion detector comprising:
a. a detector housing having an internal chamber;
b. an electrically conductive metal base mounted within said internal chamber of said detector housing, said base having a concave surface and being electrically interconnected with said electrical circuit board;
c. an electrical conductor mounted within said internal chamber of said detector housing proximate said electrically conductive base, said electrical connector being electrically interconnected with said electrical circuit board and having first and second spaced apart conductive portions; and
d. an electrically conductive metal spherical member disposed in rolling engagement with said concave surface of said base, said spherical member being movable along said concave surface between a first central position, a second position in engagement with said first conductive portion of said electrical conductor and a third position in engagement with said second conductive portion of said electrical conductor; and
(b) an indicator operably associated with said motion detector, said indicator including an indicator housing and an indicator light emitting diode connected to said indicator housing.

11. The privacy indicator as defined in claim 10 in which said spherical member comprises a brass sphere plated with nickel.

12. The privacy indicator as defined in claim 10 in which said detector housing includes a substantially transparent top viewing window.

13. The privacy indicator as defined in claim 10 in which said first and second conductive portions of said motion detector include inwardly extending spherical member engaging fingers.

14. The privacy indicator as defined in claim 10 in which said controller further includes a controller light emitting diode connected to said electrical circuit board.

15. The privacy indicator as defined in claim 14 in which said electrical circuit board comprises a battery operably associated with said controller light emitting diode to provide power thereto; a single pole single throw switch connected to said battery; and a push button four pole double throw switch operably associated with said light emitting diode.

16. The privacy indicator as defined in claim 15 in which said electrical circuit further comprises a single coil latching relay controlled by said four pole double throw switch and by said motion detector.

17. A privacy indicator apparatus comprising:
(a) a controller including:
(i) a controller housing having an internal controller chamber;
(ii) an electrical circuit board disposed within said internal controller housing, said electrical circuit board comprising a battery, a single pole single throw switch connected to said battery and a push button four pole double throw switch operably associated with said batteries;
(iii) a motion detector disposed within said internal controller chamber and operably associated with said electrical circuit board; said motion detector comprising:
a. a detector housing formed from a non-electrically conductive material, said detector housing having an internal chamber and including a substantially transparent top viewing window;
b. an electrically conductive metal base mounted within said internal chamber of said detector housing, said base having a concave surface and being electrically interconnected with said electrical circuit board;
c. a generally “U”-shaped electrical conductor mounted within said internal chamber of said detector housing proximate said electrically conductive base, said electrical connector being electrically interconnected with said electrical circuit board and having first and second spaced apart conductive portions; and
d. a nickel plated brass spherical member disposed in rolling engagement with said concave surface of said base, said spherical member being movable along said concave surface between a first central position, a second position in engagement with said first conductive portion of said electrical conductor and a third position in engagement with said second conductive portion of said electrical conductor; and
(b) an indicator operably associated with said motion detector, said indicator including an indicator housing and a controller light emitting diode connected to said indicator housing and being operably associated with said electrical circuit board.

18. The privacy indicator as defined in claim 17 in which said first and second conductive portions of said motion detector include inwardly extending, spherical member engaging fingers.

19. The privacy indicator as defined in claim 18 in which said controller further includes a controller light emitting diode operably associated with said electrical circuit board.

20. The privacy indicator as defined in claim 19 in which said electrical circuit board further comprises a single coil latching relay controlled by said four pole double throw switch and by said motion detector.
